(19) United States
(12) Patent Application Publication
(10) Pub. No.: US 2023/0296099 A1
(43) Pub. Date: Sep. 21, 2023

(54) INTEGRATED PUMP ASSEMBLY WITH ONE MOVING PART WITH STACKED STATOR

(71) Applicant: Sapphire Motors, San Leandro, CA (US)

(72) Inventors: Tracy MCSHEERY, San Mateo, CA (US); Carl PAGE, Palo Alto, CA (US)

(21) Appl. No.: 18/203,601

(22) Filed: May 30, 2023

Related U.S. Application Data
(62) Division of application No. 17/120,016, filed on Dec. 11, 2020.

(51) Int. Cl. F04D 13/06; H02K 1/12; H02K 5/128; H02K 1/27

(52) U.S. Cl. CPC F04D 13/0633; F04D 13/064; H02K 1/12; H02K 5/128; H02K 1/27; H02K 5/1732

(57) ABSTRACT

A pump assembly can pump fluid with a single moving part. The pump includes a casing with an inlet and an outlet. The pump includes an impeller to rotate inside the casing to create low pressure at the inlet and increase pressure to expel fluid from the output. The impeller is physically connected to a rotor within the pump casing. The rotor includes permanent magnets arranged radially around a surface of the rotor opposite the physical connection to the impeller. A variation replaces the magnets with a switched reluctance path. The pump includes a stator assembly within the casing, magnetically coupled to the rotor, the stator assembly having electrically controllable conductors to drive the rotor with axial flux. The stator assembly includes stacks of multiple layers of coated conductor having multiple spokes as the stator core.

### PRIORITY

This application is a divisional of, and claims priority to, U.S. application Ser. No. 17/120,16, filed Dec. 11, 2020.

### FIELD

Descriptions are generally related to pumps, compressors, and electromotive devices where traditionally a device consists of a motor, a coupling mechanism, and a rotary motion to a mechanical device to create a fluid state change, and more particular descriptions are related to an integrated pump and motor assembly. While compressors and vacuum pumps often have their own nomenclature, for simplification, we will refer to the general class of devices that move fluids as pumps.

### BACKGROUND

Pumps are an essential part of water, gas, and other fluid delivery and use systems in modern society. While many improvements in pump operation have been made over the years, the fundamental components of the pump have remained constant. A traditional pump includes the pump mechanism itself and a motor to do work on the fluid to create the pressure differences that cause the pump to operate. Motors tend to be large electromechanical assemblies to generate the work needed to pump the fluid. To create enough power, a motor often turns at higher speeds and uses gears or a transmission to convert speed to torque and deliver the desired output, which adds cost, weight and complexity but is a known proven solution. The downside is that these systems have losses inherent in each component, so that the gears, bearings, shaft seals, alignment mechanisms like shaft couplers, cooling fans, oil pumps and other peripheral devices each contribute to losses if we consider the pump as a system, not just moving the target working fluid. From a cost standpoint these additional components have manufacturing costs, maintenance costs, and replacement costs if they don't last the lifetime of the pump itself, contributing to the overall system installed cost, efficiency and reliability.

Even with the development of electric motors, the motor needs to be coupled to the pump through a shaft coupler to enable the rotational work of the motor to turn a turbine or impeller inside the pump. Such an assembly requires shaft seals, which tend to wear as the shaft rotates and eventually fail. Even with efficient motors and pumps, the assembly tends to require regular maintenance for the coupling of the pump and motor.

FIG. 1A is an example of a traditional pump with the rotor and stator enclosed in an external motor housing, often with cooling fans or systems, connected to a shaft coupler to align two shafts, and through shaft seals connected to a similar impeller, demonstrating the extra size, weight, cost, and complexity of the traditional designs. Assembly 102 includes motor 120, which is an external motor housing having the rotor and stator. Motor 120 couples to pump 110 via shaft coupler 122, which includes shaft seals and other parts that wear out over time and result in failure. Pump 110 pump liquid from inlet 112 to outlet 114.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1A is an example of a traditional pump with the rotor and stator enclosed in an external motor housing, often with cooling fans or systems, connected to a shaft coupler to align two shafts, and through shaft seals connected to a similar impeller, demonstrating the extra size, weight, cost, and complexity of the traditional designs.

FIG. 1B is an example of a pump with stator, rotor, and impeller all enclosed within the pump casing.

FIG. 2A is an example of an impeller and rotor having a base with fluid channels to allow circulation of fluid for lubrication. For clarity, the magnets or magnetic return paths not shown.

FIG. 2B is an example of the impeller and rotor of FIG. 2A having the base extended with channel outlets.

FIG. 2C is an example of an impeller and rotor having encased magnets around the base and wedges for a bearing at the end of the base.

FIG. 3 is an example of a thrust bearing for a pump assembly.

FIG. 4A is an example of a stator core with slots for conductor.

FIG. 4B is an example of the stator core of FIG. 3A, with conductor wrapped on the slots.

FIG. 4C is an example of the stator core of FIG. 3B with a protective coating over the conductor and slots.

FIG. 5A is an example of a pump core with rotor and stator connected and stator magnetically coupled.

FIG. 5B is a cutaway view of an example of the pump core of FIG. 5A.

FIG. 6A is an example of a pump casing and pump core to be integrated together.

FIG. 6B is an example of the pump casing and pump core of FIG. 6A, seen from a different angle.

FIG. 6C is a cutaway view of an example of the pump casing and pump core of FIG. 6A to be integrated together.

FIGS. 6D-6E are examples of the pump casing and pump core of FIG. 6A, assembled into a complete pump assembly.

FIG. 7 is a diagram of an example of a conductor path with folding and bending for a stator with layers of conductor.

FIG. 8A is a diagram of an example of a coated conductor sheets with three phases.

FIG. 8B is a diagram of an example of a cross section view of the stacking of the three phases of conductors into a stator assembly.

FIG. 8C is a diagram of an example of a perspective view of the stacking of the three phases of conductors into a stator assembly.

FIG. 9A is a diagram of an example of an assembly of a three phase stacked stator core.

FIG. 9B is a diagram of an example of an assembly of a three phase stacked stator core with two magnet arrays.

FIG. 10A is an example of a pump casing and pump core with a stacked stator core to be integrated together.

FIGS. 10B-10C are examples of the pump of FIG. 10A with the pump core assembled, as seen from two different perspectives.

FIGS. 10D-10E are examples of the pump casing and pump core of FIG. 10A nested together, as seen from two different perspectives.

FIG. 11 is a diagram of an example of a hybrid conductor.

FIG. 12 is a diagram of an example of a hybrid conductor winding with spacer separation.

FIG. 13 is a diagram of an example of a motor assembly with coils of hybrid conductor around wrapping slots.

Descriptions of certain details and implementations follow, including non-limiting descriptions of the figures, which may depict some or all examples, and well as other potential implementations.

### DETAILED DESCRIPTION

As described herein, a pump assembly can pump fluid with a single moving part, including the operation of the motor. Pumps can pump various types of fluid, where a fluid is generally understood to refer to liquids and gases or other substance that can be classified as a fluid. In essence, the fundamental components of a pump are the impeller, which creates velocity in the liquid through rotation, and the casing, which converts velocity into pressure. The other components of pumps essentially work to perform create operation on the impeller. If the casing is a fixed shape, fundamentally, the only part that needs to move to cause the operation of the pump is the impeller. Traditional pump designs require many moving parts to move the impeller.

However, only the impeller needs to move to cause the operation of the pump. A pump as described herein includes a casing with an inlet and an outlet. The pump includes an impeller to rotate inside the casing to create low pressure at the inlet and increase pressure to expel liquid from the output. The impeller is physically connected to a rotor within the pump casing. The rotor includes permanent magnets arranged radially around a surface of the rotor opposite the physical connection to the impeller. The pump includes a stator assembly within the casing, magnetically coupled to the rotor, the stator assembly having electrically controllable conductors to drive the rotor with axial flux. Through control of the stator, the pump will cause the rotor to move, which will move the impeller. When the rotor and impeller are connected to move together, operation of the stator to move the rotor necessarily moves the impeller. Thus, the pump includes only a single moving part. The integrated pump includes a pump and motor components integrated into a single housing. The integration of the motor within the pump housing eliminates many parts, and reduces size, weight, and cost while increasing reliability and efficiency of the fluid action.

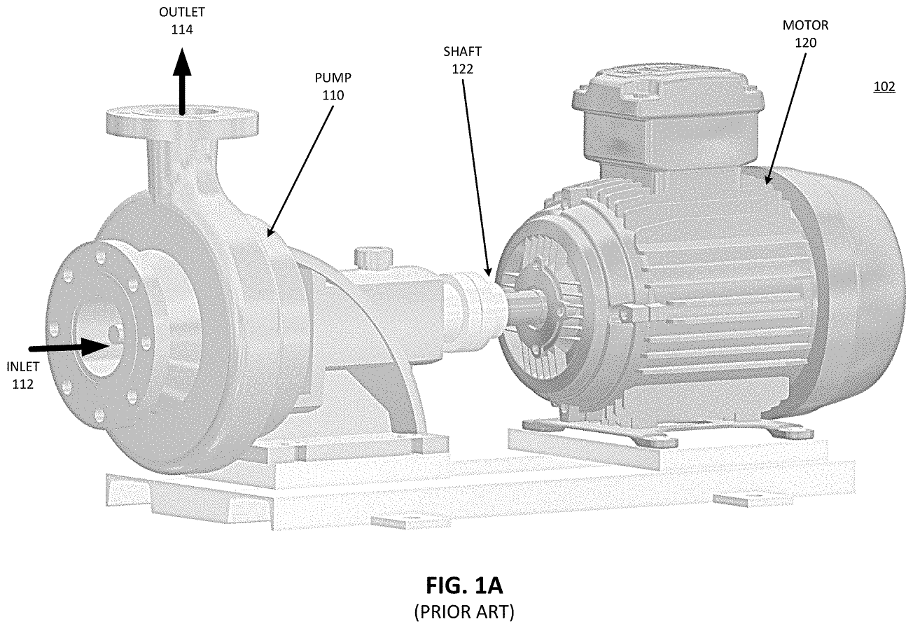

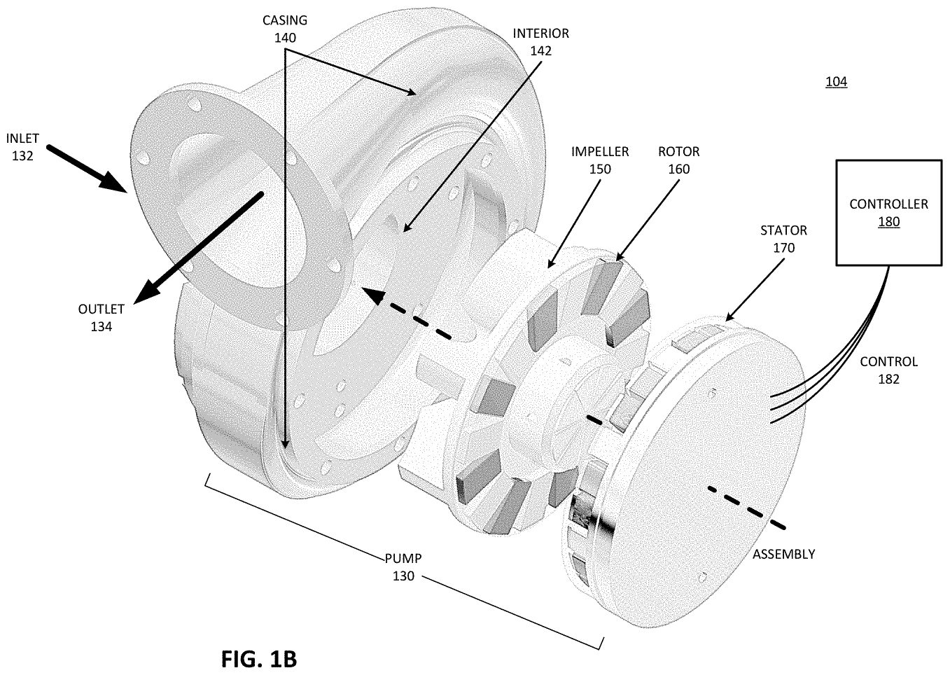

FIG. 1B is an example of a pump with stator, rotor, and impeller enclosed within the pump casing. System 104 includes pump 130 and controller 180 to drive the internal motor for the pump. Pump 130 represents a pump with a single moving part. Such a pump provides increased efficiency in any application where a pump is used. Pump 130 also reduces cost of the pump due to fewer parts. Pump 130 improves reliability given that external motor parts and accompanying seals are eliminated in the pump design.

Pump 130 includes an impeller to be enclosed within the pump, and a stator to be combined with or integrated with the impeller. Impeller 150 provides an example of an impeller. Impeller 150 includes blades, fins, or teeth that cause fluid to move through pump 130.

Impeller 150 and rotor 160 are combined in pump 130. The combination of impeller 150 and rotor 160 can be implemented in different ways. In one example, rotor 160 and impeller 150 are made as separate elements that are combined and integrated, such as through welding, securing with screws, or through some other integration. In one example, impeller 150 includes both blades and a base that includes the magnetic elements to implement the rotor.

In one example, the combination of impeller 150 and rotor 160 can be considered an impeller that includes rotor elements, such as single piece impeller that also includes magnets on it. In one example, the magnets on rotor 160 are permanent magnets. In one example, the combination of impeller 150 and rotor 160 can be considered a rotor that includes one or more structures on it to act as an impeller.

The combined rotor and impeller structure includes an impeller on one side of the combined structure and rotor magnets on the opposite surface of the combined structure. Thus, considering the combined structure to generally have a disk shape, one side of the disk includes impeller structures and the other side of the disk includes rotor structures. However the structure is understood, pump 130 includes rotor 160 physically connected to impeller 150. Impeller 150 rotates inside casing 140 to create low pressure at inlet 132 to pull liquid into pump 130, and increase pressure to expel the liquid from outlet 134. Inlet 132 is obscured from view in system 104, on the opposite side of casing 140 from where the assembly of pump 130 is enclosed within casing 140.

Stator 170 represents a stator assembly or stator structure to driver rotor 160, and consequently, to drive impeller 150. Stator 170 includes electromagnetic components, such as conductor coils, to selectively drive the combination of rotor 160 and impeller 150. With magnets on rotor 160, current flowing through coils on stator 170 that generate electromagnetism will cause a magnetic coupling between rotor 160 and stator 170. Thus, stator 170 can be magnetically coupled to the rotor based on electrically controllable conductors to drive the rotor with axial flux.

In one example, stator 170 operates based on a controller that drives the motor as a switched-reluctance motor. In a switched-reluctance motor, different combinations of coils are alternately charged to cause alignment of magnets of rotor 160, which has a different number of magnets than stator 170 has of coils. The alternate charging causes the rotor to rotate as the magnets are aligned based on the changing electromagnetic field generated by the coils of stator 170.

Controller 180 represents an improved controller that enables system 104 to take advantage of design needs and give a surge of power to the motor as needed. The surge of power can momentarily provide 2× to 4× the nominal or average power. Controller 180 connects to the motor through stator 170, with wires that connect electrically to the coils of the stator. Controller 180 includes hardware to selectively charge or drive the coils. Controller 180 can control how much current to apply to stator 170, which enables the controller to drive the motor at a nominal rate or selectively overdrive the motor for certain periods of time. The ability to control the motor to overdrive the operation enables pump 130 to be smaller, and more affordable, as well as optimized for the use with the best efficiency. Controller 180 is represented as being connected to the motor by three control signal lines (control 182). The number of signal lines for controller to control the motor can vary, depending on the system design.

In one example, controller 180 is built on the back of stator 170. Controller 180 connects to coils of stator 170 and controls the supply of power to control the operation of the motor. Control 182 represents the connections between controller 180 and stator 170, which can include wires to drive one or more phases of coils in the motor. Stator 170 can include connection points on the surface seen in system 104. Controller 180 can be a separate component that is not necessarily located at the same place as pump 130, for example, directly inline with pipes to pump fluid. Controller 180 can be close to pump 130, built on the back of stator 170, or located some distance from pump 130.

Pump 130 includes casing 140, which encloses impeller 150 and rotor 160. In one example, the back side of stator 170 operates as a back plate for pump 130. Thus, the stator assembly can be within casing 140. Casing 140 can be essentially the same as a traditional pump casing, which would include a back plate and seal to connect an axle or shaft to impeller 150 in a traditional pump. A traditional pump assembly includes a pump, a shaft coupler, and a motor to drive the shaft that turns the impeller in the pump. In one example, pump 130 is a radial flux motor, with the motor components enclosed within casing 140, fitting within interior 142 within casing 140.

Moving the motor components within casing 140 eliminates the motor assembly as separate components, which greatly reduces size. Pump 130 includes rotor 160 with integrated impeller 150 and stator 170, which can replace a traditional impeller and back plate with an axial flux motor. Removing bulky motor and shaft components also reduces the cost and complexity of the pump assembly, eliminating the need for separate couplers and seals, which tend to wear out over time.

In one example, casing 140 is a volute casing. Volutes are designed to capture the velocity of liquid as it enters the outermost diameter of the impeller and convert the velocity of the liquid into pressure. With a volute casing, impeller 150 may be located offset from a center of casing 140. The portion of the volute that extends closest to the impeller is referred to as the cutwater. Starting from the cutwater and proceeding in a counterclockwise fashion along casing 140, the distance between the volute and the impeller increases gradually. The gradual increasing of the distance of the volute casing channel from impeller 150 has the effect of causing pressure to build within the volute as the distance increases. Once the point of greatest separation is reached, directly next to the cutwater moving in the clockwise direction, the pressure of the fluid is at its greatest, and liquid is forced out the casing when it encounters the cutwater. Outlet 134 represents the outflow for casing 140. Outlet 134 expels liquid from pump 130 after coming into the pump through inlet 132. Inlet 132 represents an intake for pump 130, which allows liquid in to casing 140, which is then accelerated by the radial motion of impeller 150. Inlet 132 can represent an inlet for casing 140 and thus, for pump 130. In one example, inlet 132 provides an intake at a center of impeller 150.

Casing 140 is illustrated as a volute casing. It will be understood that the combined impeller 150 and rotor 160 with stator 170 within the casing can also be applied to a diffuser casing. Whether a volute casing or a diffuser case, pump casings are designed to take energy in the form of velocity and convert it into pressure. A diffuser casing generates the velocity to pressure conversion that a volute casing will create, while minimizing radial thrust by balancing the thrust across the impeller.

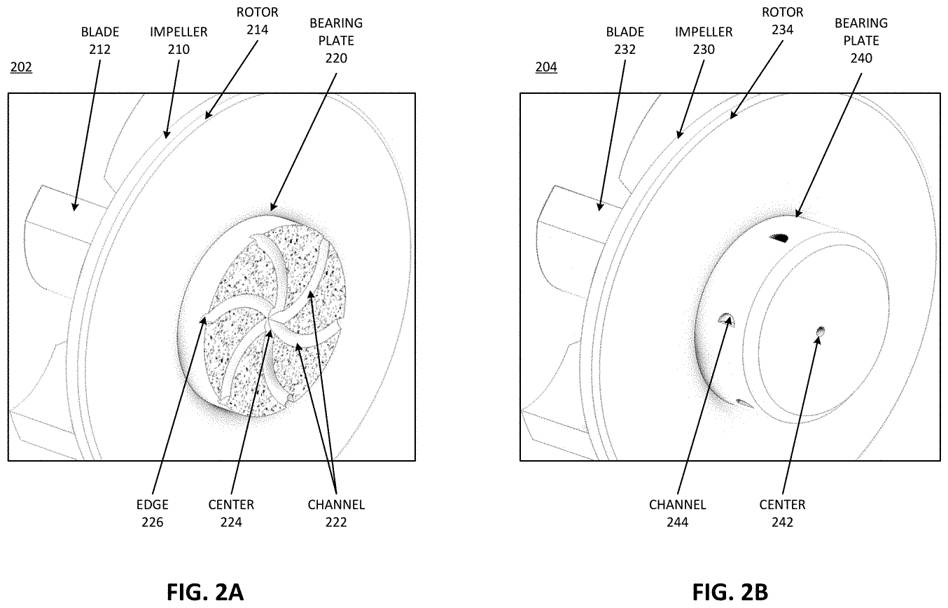

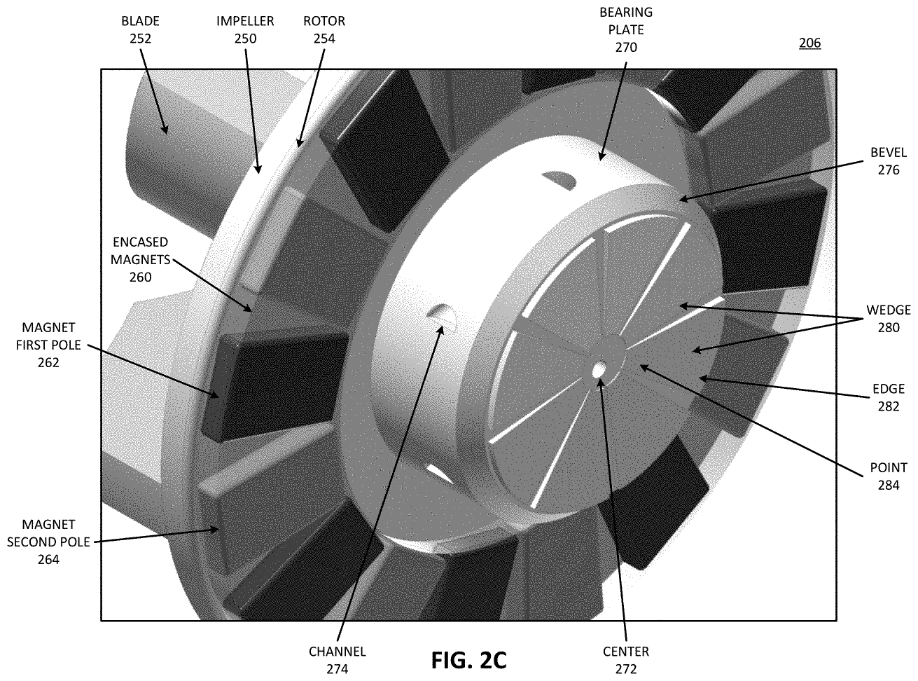

FIG. 2A is an example of an impeller and rotor having a base with fluid channels. Diagram 202 represents an example of a combination of rotor and impeller in accordance with an example of system 104.

Impeller 210 represents an impeller physically coupled with rotor 214. Impeller 210 includes a base, which can be integrated with rotor 214 or can be the base for rotor 214, and includes blades 212. It will be understood that the design of blades 212 are consistent with the example of system 104 and can be designed differently for different types of pump casing (e.g., volute versus diffusion) or for different implementations of a pump design (e.g., different blade or fin designs for different volute casings).

Rotor 214 includes a base that can be the same as the base of impeller 210 or can be a separate base that is physically attached to impeller 210. Diagram 202 does not illustrate the magnets that would be disposed on the visible surface of rotor 214.

Diagram 202 illustrates a base that extends from rotor 214. In one example, the extended base can be designed as a bearing plate. Diagram 202 illustrates a cutaway view of bearing plate 220, which illustrates a center within the bearing plate, and channels 222 that extend from center 224 to edges 226. Center 224 is at the center of bearing plate 220, while channels 222 extend radially out toward edges 226, which are near the magnets that will be on rotor 214.

It will be observed that channels 222 have curvature, spiraling out from center 224 to edge 226, or spiraling from edge 226 toward center 224. Channel 222 can provide a conduction channel to force high pressure fluid back toward the low pressure center, effectively cycling the working fluid through the base. In one example, channels 222 extend out from center 224 towards counter rotating holes. The holes are counter rotating because the channels spiral the opposite way as blades 212. In different impeller designs, channels 222 will not necessarily be counter rotating with respect to blades 212.

FIG. 2B is an example of the impeller and rotor of FIG. 2A having the base extended with channel outlets. Diagram 204 represents an example of a combination of rotor and impeller in accordance with an example of system 104. Diagram 204 represents one example of a rotor and impeller in accordance with diagram 202, where diagram 202 can be a cutaway of diagram 204.

Impeller 230 represents an impeller physically coupled with rotor 234. Impeller 230 includes a base, which can be integrated with rotor 234 or can be the base for rotor 234, and includes blades 232 on a surface opposite the rotor. Rotor 234 includes a base that can be the same as the base of impeller 230 or can be a separate base that is physically attached to impeller 230. Diagram 204 does not illustrate the magnets that would be disposed on the visible surface of rotor 234.

Diagram 204 illustrates a base that extends from rotor 234. In one example, the extended base can be designed as a bearing plate. Diagram 204 illustrates bearing plate 240, which illustrates a center within the bearing plate, and channels 244 that extend from center 242 to the edges of bearing plate 240. Center 242 is at the center of bearing plate 240, while channels 244 extend radially out from center 242. A high pressure and rotating scooping action at 244 will cause fluid to flow to a low pressure center at 242 to circulate fluid.

The shape of the opening of channel 244 has a flat portion and an arch connected to the ends of the flat portion. Thus, the shape is a half-circle or half-ellipse on the edges of bearing plate 240. In one example, the opening of channel 244 is connected to a spiral channel (such as what is illustrated in diagram 202), which has a counter-rotating feature. In a counter-rotating design, when rotor 234 and impeller 230 rotate counter-clockwise, fluid will pump through channel 244 to center 242. Thus, high pressure fluid pumps in channel 244 toward low pressure at center 242.

FIG. 2C is an example of an impeller and rotor having encased magnets around the base and wedges for a bearing at the end of the base. Diagram 206 represents an example of a combination of rotor and impeller in accordance with an example of system 104. Diagram 206 represents one example of a rotor and impeller in accordance with diagram 204, where the extension has features on the end to provide bearing functions.

Impeller 250 represents an impeller physically coupled with rotor 254. Impeller 250 includes a base, which can be integrated with rotor 254 or can be the base for rotor 254, and includes blades 252 on a surface opposite the rotor. Rotor 254 includes a base that can be the same as the base of impeller 250 or can be a separate base that is physically attached to impeller 250.

Rotor 254 includes encased magnets 260. In one example, encased magnets 260 include rare-earth permanent magnets. The magnets are encased in epoxy, resin, or some other material that can withstand high temperature and provide a smooth surface for the magnets. The magnets are arranged or disposed radially around rotor 254, with the center of the magnets aligned with a radius of rotor 254. Alternatively, the magnets can be replaced by teeth in a suitable switched reluctance configuration. It will be understood that the magnets create a magnetic return path for the stator. The teeth in the switched reluctance configuration can also create a magnetic return path for the stator. The magnetic return path is dynamic but fixed to the rotor impeller assembly or equivalent in the pumping action.

In one example, encased magnets 260 include magnets are arranged in alternating north and south orientations. If magnet first pole 262 is a north pole, then magnet second pole 264 is a south pole. Alternatively, if magnet first pole 262 is a south pole, then magnet second pole 264 is a north pole. The different colors of the magnets illustrate that the magnets can be arranged in alternating poles around the entire 360 degrees of the surface of rotor 254. Thus, in one example, the number of encased magnets 260 is an even number of magnets. The center of a circle including encased magnets 260 can be in line with center 272, at the center of the surface of rotor 254 opposite blades 252 of impeller 250.

Diagram 206 illustrates bearing plate 270 that extends from the surface of rotor 254 that includes encased magnets 260. In one example, there is a gap of space between encased magnets 260 and bearing plate 270. The space and the amount of the gap of space is a design choice. Bearing plate 270 includes center 272 and channels 274 which connect to center 272 within bearing plate 270. Center 272 is at the center of bearing plate 270, while channels 274 extend radially out from center 272 toward encased magnets 260. The shape of the opening of channel 274 is a half-circle or half-ellipse on the edges of bearing plate 270. In one example, the opening of channel 274 is connected to a spiral channel (such as what is illustrated in diagram 202), which has a counter-rotating feature.

In a traditional motor, inside the pump there are bearings around a shaft, and a shaft seal that has to keep the fluid in, while supporting rotation at high speed. The integration of impeller 250 with rotor 254 can still benefit from a bearing for the magnetic coupling of the rotor with a stator. Ideally, the stator would never come into physical contact with any part of rotor 254.

In one example, bearing plate 270 includes end features to provide an interface with a stator that can maintain physical separation of the components through the use of the liquid pumped with the pump it is integrated into. In one example, at the end of bearing plate 270 that extends farthest away from the surface of rotor 254 on which encased magnets 260 are disposed includes bevel 276. Bevel 276 is beveling of the outer edge of bearing plate 270. More specifically, bearing plate 270 can be shaped as a cylinder with the outer edge of the cylinder meet the end circular surface of the cylinder at 90 degrees, the outer edge and the end surface meet at an angle less than 90 degrees. Bevel 276 is illustrated at approximately 45 degrees, and will be understood as one non-limiting example.

In one example, bearing plate 270 is generally cylindrical. Thus, bearing plate 270 provides an example of a cylindrical base to the rotor or impeller. In one example, the end surface of bearing plate 270 includes wedges 280. The wedge shaped features on bearing plate 270 create high pressure at edges 282, which lift the surface away from the stator plate. Additionally, having the wedge shapes thicker at edge 282 and tapered both width-wise as well as height-wise will remove fluid as the rotor and impeller rotate. Thus, wedges 280 can be thicker at edge 282 and thinner at point 284 which is the closest part of wedge 280 to center 272.

For rotor 254, encased magnets 260 are encased in a protective coating, and bearing plate 270 includes wedges 280 to create a bearing. In operation, fluid will be pumped out to the rim by the rotation, creating a low pressure area at center 272, creating constant fluid flow into the interface between the stator and rotor 254.

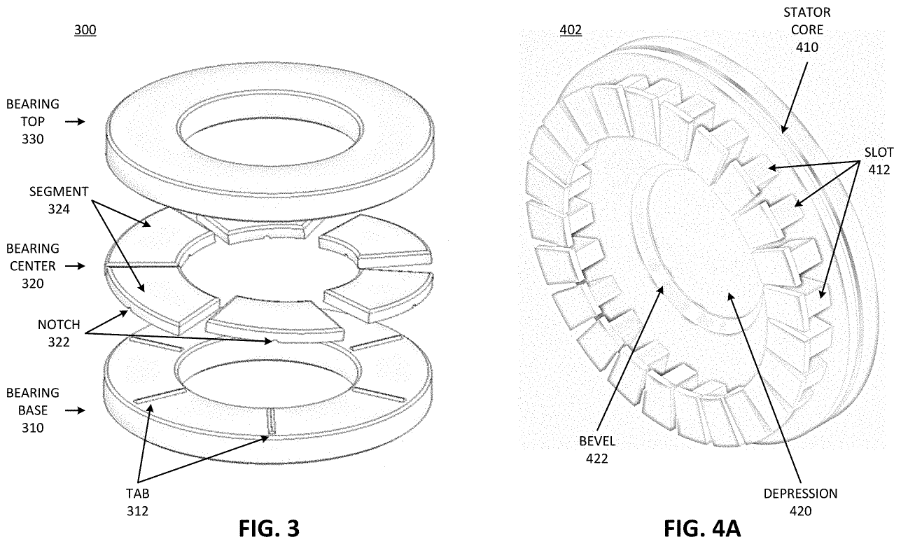

FIG. 3 is an example of a thrust bearing for an integrated pump motor assembly. A motor with a rotor and a stator integrated within the pump casing can include a thrust bearing to handle the thrust load between the rotor and the stator. When the impeller of a pump rotates at high speed within the casing, a significant amount of thrust force can be created that is exerted orthogonal to a plane in which the impeller blades spin.

In the case of a motor with an integrated impeller and rotor, such as a motor in accordance with an example of system 104, the impeller and rotor combination can exert thrust force against the stator and its base, which acts as a back plate to the pump. In one example, bearing plate 270 of diagram 206 can include a thrust bearing in accordance with bearing 300, instead of having the wedges.

Bearing 300 can be referred to as a shoe bearing or a tilting pad bearing, and is commonly referred to as a KINGSBURY bearing, such as those available from MESSINGER BEARINGS. All trademarks are the property of their respective owners, and are used here merely for identification. There are multiple types and designs of tilting pad bearings, with bearing 300 showing a simplified design of commonality between them. Other features and complexities in the bearings could be employed as appropriate.

Bearing 300 can be used to offset the thrust exerted by a combined rotor and impeller in accordance with what is illustrated in diagram 206. In one example, the bearing plate could include a bevel. In one example, with bearing 300, the bearing plate does not include a bevel.

The diagram of bearing 300 illustrates a gap through the center of the components, which can enable liquid to exit a center in the bearing plate to lubricate the bearing. The gap could be smaller than what is illustrated. Bearing 300 can be oriented either direction between the stator and rotor. For purposes of one example, consider that a bearing plate of the rotor includes bearing top 330, and a corresponding stator includes a depression area with bearing center 320 and bearing base 310. For purposes of the following description a configuration will be assumed where bearing base 310 is affixed to or within a depression of the stator core, and the bearing top is affixed to, or is part of, the bearing plate of the rotor.

Bearing base 310 includes tabs 312, which fit to corresponding notches 322 of segments or pads of bearing center 320, identified as segments 324. The notch and tab configuration enables segments 324 to tilt under pressure. The tilting motion spreads the thrust over the entire bearing body. Force exerted into bearing top 330 from the rotor will be thrust into bearing center 320 and bearing base 310, with the moving segments 324 to distribute the exerted thrust force.

In one example, the bearing plate can alternatively or additionally include a magnetic bearing to offset radial load or thrust load, or a combination of radial load and thrust load. A magnetic bearing includes permanent magnets affixed to opposite components, with opposite poles facing each other. Thus, the bearing plate can include magnets all having one pole orientation, and the stator core can include magnets having the opposite pole being exposed to the magnets of the bearing plate.

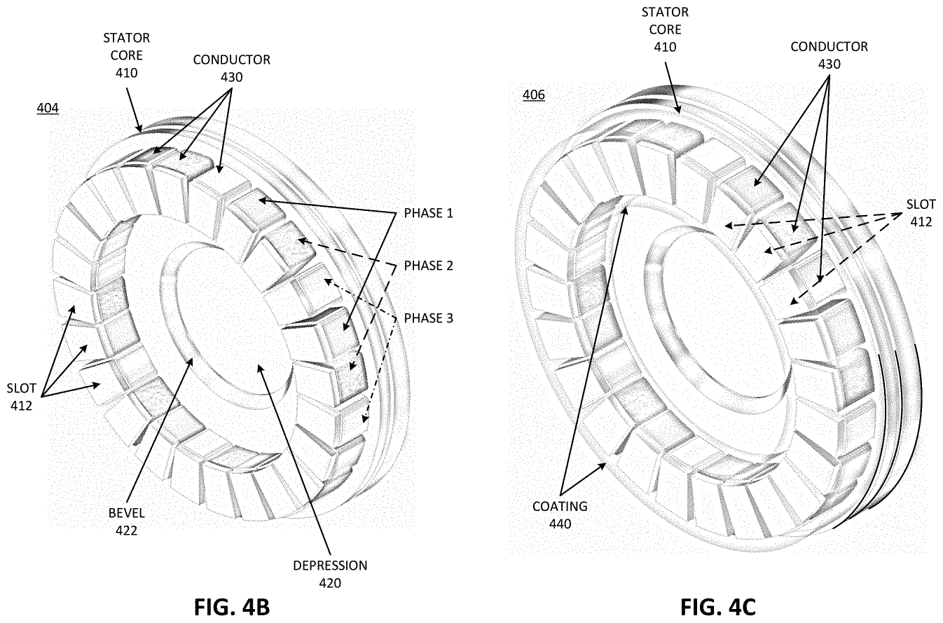

FIG. 4A is an example of a stator core with slots for conductor. Stator 402 illustrates a stator that can function with a combined impeller and rotor in accordance with an example of diagram 206. Stator 402 includes stator core 410 and slots 412.

Stator core 410 represents a metallic core, such as iron, steel, or other conductive material. In one example, stator core 410 is a steel plate. In one example, stator core 410 includes bevel 422 that transitions from one inner surface of stator core 410 to another inner surface of the stator core. The two inner surfaces can be related as concentric circles, with bevel 422 transitioning to depression 420. Depression 420 represents an area at the center of stator core 410 that is lower than the surface from which slots 412 protrude. Bevel 422 would match a corresponding bevel on an edge of a bearing plate of a rotor that interfaces with stator 402. Depression 420 can likewise have a depth that corresponds to the shape and depth of a corresponding rotor, understanding that the structures can be designed to not physically contact each other.

Slots 412 represent slots on which conductor will be wound for stator 402. In one example, slots 412 have a ‘T’ shape, with a post having a cap. The windings will provide the ability of a controller to drive current in a conductor wound around each slot 412, creating flux that will cause an electromagnetic field to interact with magnets in the corresponding rotor. The windings can be referred to as conductive coils.

FIG. 4B is an example of the stator core of FIG. 4A with conductor wrapped on the slots. Stator 404 illustrates stator 402 with conductor wound around slots 412. Stator 404 includes bevel 422 and depression 420. In one example, the depression can have magnetic thrust and radial thrust bearings using the fluid to be pumped for lubrication.

Slots 412 are illustrated with conductor 430 wound around each slot. In one example, conductor 430 is ribbon wire. A ribbon wire can have a width approximately equal to the height of the post of slots 412. In one example, multiple ribbon wires can be wound around slots 412, with the width of the ribbon wires being a multiple divisor of the height of the post of slot 412. In one example, traditional round wire can be used around slots 412, although ribbon wires would increase conductor density and promote higher flux for stator 404. In one example, conductor 430 is copper wire. In one example, conductor 430 is aluminum wire. In one example, conductor 430 is coated with an insulative coating.

Conductors 430 can be coils arranged to provide optimal torque and speed for stator 404. Improved torque and speed will provide improved efficiency at the pump speed and pump rate for the pump design. Conductors 430 are arranged in multiple phases, where each phase is separately controlled by an associated controller (not illustrated). The alternated charging of different phases causes different magnetic flux patterns to appear at the top of slots 412, which will interact with magnets of a corresponding rotor to drive rotation of the rotor as the magnets align with the magnetic flux patterns of the electromagnetic fields produced.

In one example, stator 404 includes three separate phases, Phase 1, Phase 2, and Phase 3. The different phases can be placed in sequential order around stator core 410. Thus, in one example, stator 404 includes a number of slots 412 that is a multiple of 4. The conductors for the different phases are electrically tied together to the same driver circuit of the controller, to cause all conductors of the same phase to charge together. Thus, stator 404 can include electrically controllable conductors to be driven in multiple phases.

FIG. 4C is an example of the stator core of FIG. 4B with a protective coating over the conductor and slots. Stator 406 illustrates stator 404 with coating 440 around the conductors. Coating 440 can be the same or similar to the coating used around encased magnets of a corresponding rotor. In one example, different coatings are used to encase magnets of the rotor and to encase stator slots 412 wrapped with conductor 430. Coating 440 can both protect the windings and reduce turbulence from fluid, while the coating allows cooling of the coils.

As with the coating of the magnets in the rotor, coating 440 can be a protective coating that allows immersion of the conductors in fluid. In one example, the coatings also provide direct cooling, when made of material that provide good thermal conduction. It will be understood that the drag is no different than the impeller drag that would have been experienced without the coated conductors and coated magnets. When the coating promotes heat transfer, the overall system drag can be reduced relative to a traditional pump and motor assembly, while reducing or eliminating cooling requirements for the system.

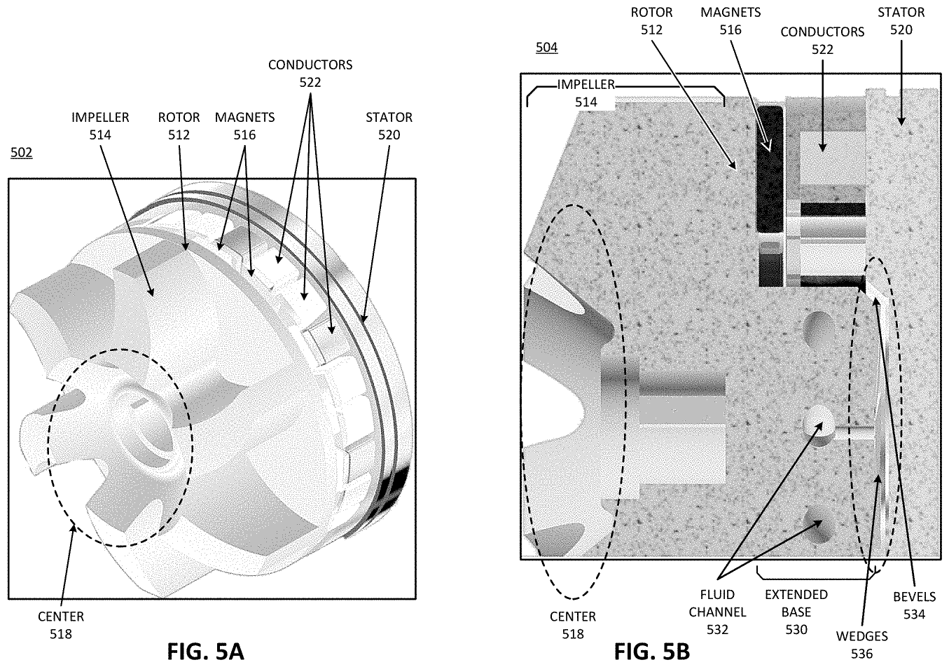

FIG. 5A is an example of a pump core with rotor and stator connected and stator magnetically coupled. Motor assembly 502 provides a pump core for a pump in accordance with an example of system 104.

Motor assembly 502 includes rotor 512 integrated with or connected to impeller 514. Motor assembly 502 includes stator 520 to drive rotor 512, which will rotate impeller 514 as rotor 512 spins. Rotor 512 includes magnets 516 disposed on the opposite surface of rotor 512 as impeller 514. Magnets 516 face stator 520. Stator 520 both serves as a cover plate in this example, and as a magnetic flux return path as the stator teeth are energized by the coils to create rotating magnetic fields driving the rotor motion.

In one example, stator 520 includes conductors 522 wrapped around slots on stator 520. Motor assembly 502 includes a rotor and stator that provide the actions of both pump and motor with a single moving part. In one example, the pump includes a shaft to extend through center 518, which can include ceramic bearings for additional stability of the operation of the motor. The shaft can be fixed to the body of the pump casing. Liquid will enter the pump through center 518, and some of the liquid can pass through rotor 512 to lubricate the interface between rotor 512 and stator 520.

The example of motor assembly 502 (and other examples and descriptions throughout) are specific to the rotor being combined with the impeller (e.g., combined rotor 512 and impeller 514). Such examples are illustrative, but not limiting. In one example, the rotor is combined with the impeller. In one example, the stator is combined with the impeller. In general, implementations that provide signaling to stationary components will be more practical than designs that try to signal and power moving parts. Thus, for a stator that is electrically switched, having the stator being stationary while the rotor is integrated with the impeller to make the impeller move in response to powering the stator will be a more practical design.

FIG. 5B is a cutaway view of an example of the pump core of FIG. 5A. Motor assembly 504 represents a cutaway view of motor assembly 502. The cutaway view is seen from the side, as compared to the perspective view for motor assembly 502.

Motor assembly 504 illustrates impeller 514 and center 518 as the center of impeller 514. In one example, impeller 514 is attached to rotor 512. Rotor 512 includes magnets 516 on a surface of the rotor that faces stator 520. Stator 520 includes conductors 522 to generate time-varying electromagnetism. Thus, magnets 516 will pull toward stator 520.

In one example, motor assembly 504 includes a bearing to maintain gap spacing between magnets 516 of rotor 512 and conductors 522 of stator 520. In one example, rotor 512 includes extended base 530 to extend beyond magnets 516 toward stator 520, and through a gap in conductors 522. In one example, extended base 530 includes wedges 536, or a tilting pad bearing, or a magnetic bearing, to align with a depression in stator 520. The depression is illustrated with bevels 534, which can be beveled, but are not necessarily beveled depending the bearing implementation selected.

In one example, extended base 530 includes fluid channels 532 to create a constant flow of the liquid circulated by motor assembly 504 and impeller 514. The constant flow can cause liquid to flow constantly between stator 520 and rotor 512, which can lubricate the bearing design chosen. In addition to the bearing, in one example, the housing of the pump that houses motor assembly 504 can be designed to ensure that stator 520 and rotor 512 never physically contact each other.

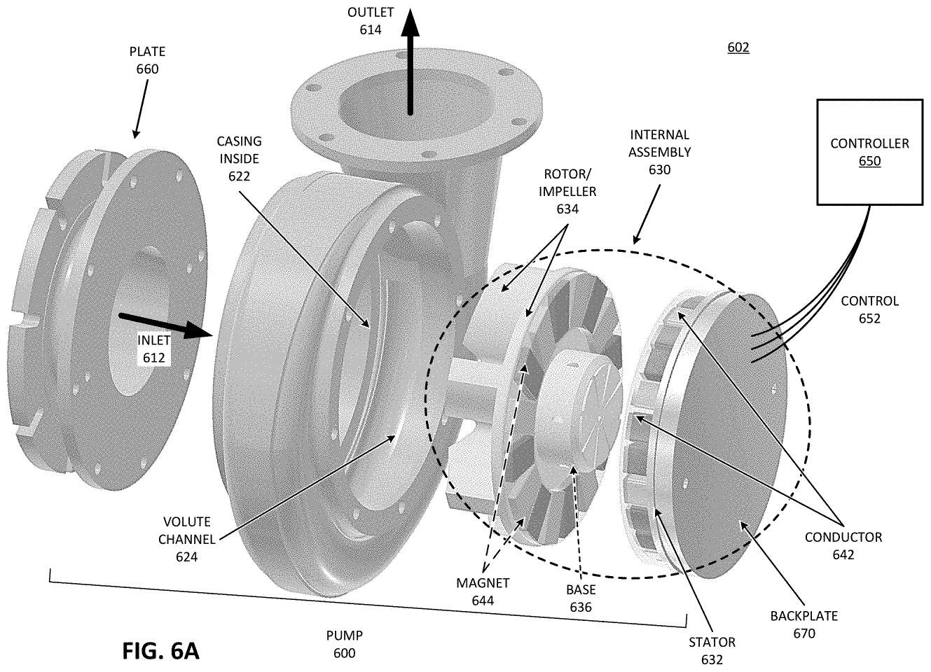

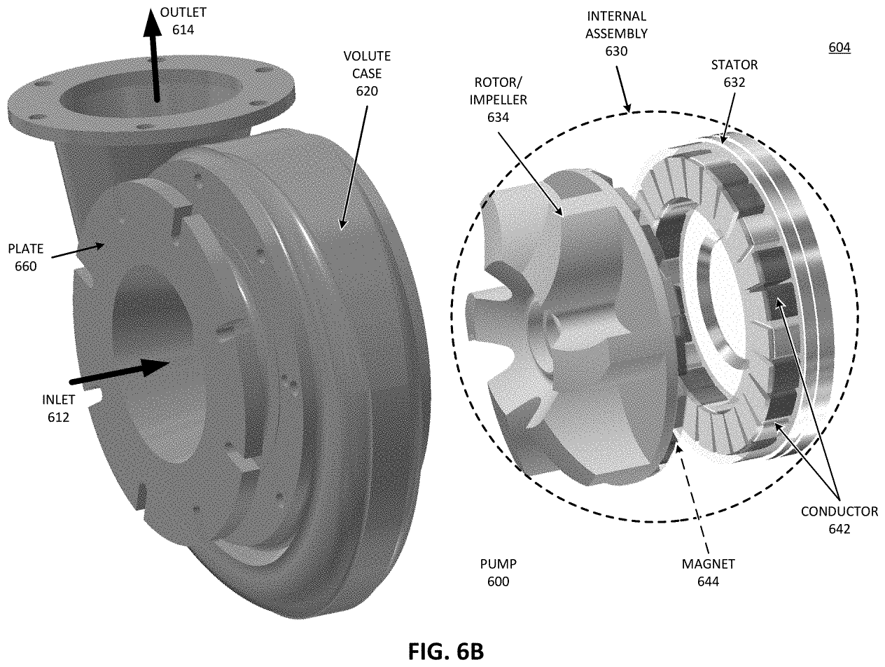

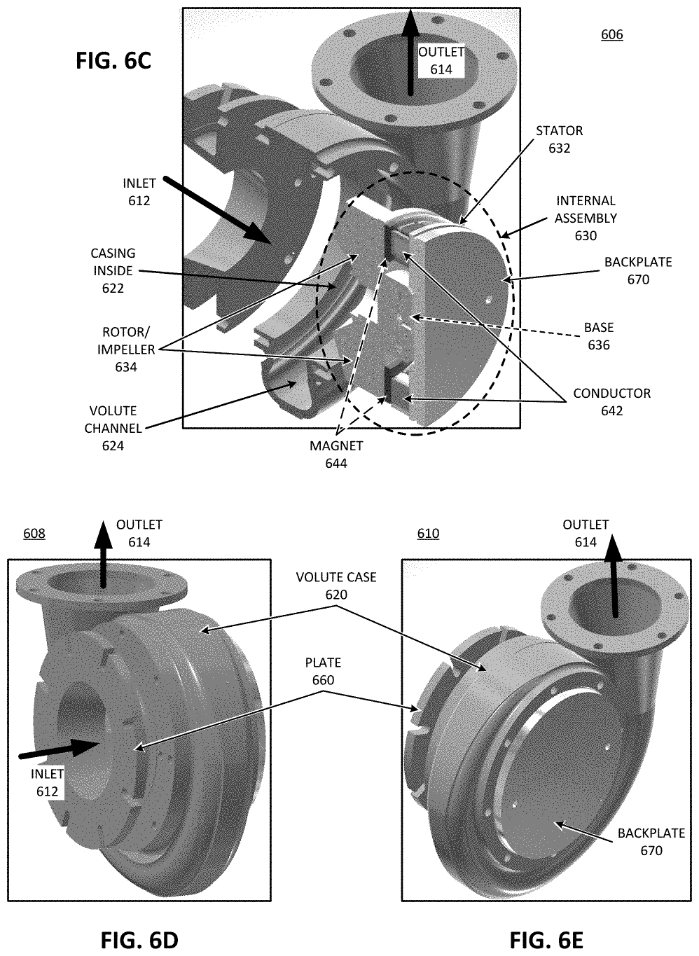

FIG. 6A is an example of a pump casing and pump core to be integrated together. View 602 illustrates pump 600, which can be a pump in accordance with an example of system 104. Pump 600 includes a motor assembly in accordance with an example described, and includes a volute casing or volute housing. It will be understood that pump 600 could be implemented as a diffuser pump with a different housing design, which may also result in a different impeller design. Despite a different impeller blade shape, the impeller can still be integrated with a rotor in accordance with any example herein.

Pump 600 includes inlet 612 through plate 660 to receive liquid and outlet 614 to expel liquid. Pump 600 includes internal assembly 630, which represents an internal motor assembly with an integrated impeller and rotor to result in a pump with a single moving part. Internal assembly 630 includes stator 632, which also acts as a back plate for pump 600. Plate 660 represents a front plate for pump 600, or a plate that covers the side of the pump that interfaces with the intake. Internal assembly 630 includes rotor/impeller 634 to convert velocity into pressure to pump the liquid from inlet 612 to outlet 614.

Rotor/impeller 634 includes magnets 644 and base 636. Base 636 represents an extended base that can include a bearing in accordance with any example described. Stator 632 includes conductor 642 to be selectively driven by a controller to cause the operation of the pump. In one example, magnets 644 are replaced by teeth for a switched reluctance configuration.

In one example, pump 600 includes a volute housing or volute case. Pump 600 illustrates the inside of the volute housing or casing inside 622. The inside represents an area where internal assembly 630 will be secured. Pump 600 also illustrates volute channel 624, which represents a volute with gradually expanding radius relative to a center of internal assembly 630, to cause the movement of the fluid. Volute channel 624 leads to outlet 614.

Integrating internal assembly 630 into the volute housing provides a simple system with a single moving part. In one example, the volute design is injection molded for low pressure applications. In one example, the impeller is injection molded for low pressure applications. Low pressure applications may not require the structural strength of metal, and can thus be made with lower cost materials that can be injection molded, such as resin or plastics. Alternatively, the casing could be implemented with ceramic materials. High pressure applications can be implemented with metal components.

View 602 illustrates controller 650 to drive the internal motor for pump 600. Control 652 represents control signal lines from controller 650 to the electronics of the integrated pump and motor. Control 652 selectively drives the conduction in the coils of the internal or integrated motor components within the pump, causing the pump to spin rotor/impeller 634. In one example, controller 650 controls the stator coils as multiple phases.

FIG. 6B is an example of the pump casing and pump core of FIG. 6A, seen from a different angle. The perspective of pump 600 in view 604 illustrates inlet 612 into plate 660, to input liquid to volute case 620. Internal assembly 630 can be seen again to include rotor/impeller 634 and stator 632. The blades of rotor/impeller 634 are more visible in view 604. Rotor/impeller 634 includes magnets 644 on the back of the structure, and conductors 642 are visible for stator 632. The back plate is behind stator 632 in view 604.

FIG. 6C is a cutaway view of an example of the pump casing and pump core of FIG. 6A to be integrated together. View 606 illustrates pump 600 in accordance with an example of view 602.

View 606 illustrates inlet 612 to receive liquid and outlet 614 to expel liquid. View 606 illustrates internal assembly 630, which represents an internal motor assembly with an integrated impeller and rotor to result in a pump with a single moving part. Internal assembly 630 includes stator 632, which also acts as a back plate for pump 600. Internal assembly 630 includes rotor/impeller 634 to convert velocity into pressure to pump the liquid from inlet 612 to outlet 614.

Rotor/impeller 634 includes magnets 644 and base 636. Base 636 represents an extended base that can include a bearing in accordance with any example described. Stator 632 includes conductor 642 to be selectively driven by a controller to cause the operation of the pump.

In one example, pump 600 includes a volute housing or volute case. View 606 illustrates the inside of the volute housing or casing inside 622. The inside represents an area where internal assembly 630 will be secured. View 606 also illustrates volute channel 624, which represents a volute with gradually expanding radius relative to a center of internal assembly 630, to cause the movement of the fluid. Volute channel 624 leads to outlet 614.

Integrating internal assembly 630 into the volute housing provides a simple system with a single moving part. In one example, the volute design is injection molded for low pressure applications. In one example, the impeller is injection molded for low pressure applications. Low pressure applications may not require the structural strength of metal, and can thus be made with lower cost materials that can be injection molded. High pressure applications can be implemented with metal components.

FIG. 6D is an example of the pump casing and pump core of FIG. 6A, assembled into a complete pump assembly. View 608 represents a fully assembled version of pump 600, illustrating inlet 612 through plate 660. Volute case 620 provides the pump casing, and holds the combination of rotor, impeller, and stator. Internal assembly 630 is fitted within volute case 620 and secured in place.

FIG. 6E is an example of the pump casing and pump core of FIG. 6A, assembled into a complete pump assembly. View 610 represents a fully assembled version of pump 600, illustrating that internal assembly 630 is fitted within volute case 620 and secured in place by backplate 670. Thus, volute case 620 provides the pump casing, and holds the combination of rotor, impeller, and stator.

In one example, pump 600 has cooling and bearing lubrication provided by the working fluid itself. In one example, internal assembly 630 includes a highly efficient axial flux motor assembly. Thus, pump 600 has significant cost reductions compared to traditional pump assemblies that require a standard motor, shaft coupler, bearings, shaft seals, and other components. Furthermore, removing these components dramatically reduces failure points as compared to a traditional pump assembly.

A traditional motor tends toward over-specification, due to designing the traditional motor for peak load to avoid burnout of the motor. Such a design increases size and cost and leads to inefficient operation, even when the motor rating is highly efficient. The motor assembly of internal assembly 630 can be designed for average power with the ability to overdrive the motor for short periods when peak loading occurs.

Typical high power brushless motors have a rotor that is one half to one quarter the diameter of the motor itself or one half to one quarter the outer diameter of the case. By using an axial flux design, the motor assembly of internal assembly 630 can have a rotor with two times (2x) the rotor diameter as compared to a traditional motor designed for a pump with the same capacity or rating as pump 600. Additionally, the motor assembly can have twice the number of magnetic poles due to the larger circumference, and twice the magnet length due to the larger radius. Given that the features multiply, the motor assembly of internal assembly 630 will provide eight time (8x) the power and torque at the same rotational speed as a traditional motor designed for pump 600.

The application of an integrated pump in accordance with pump 600 can be for any number of liquid pump applications. Examples can include, but are not limited to, gear oil pumps, hot oil pumps, water pumps (whether single stage, double stage, multistage, or pipe pumps). The examples can include horizontal or vertical multistage pumps, self-priming pumps, submersible pumps, screw pumps, belt gear pumps, portable gear pumps, lobe pumps, or diaphragm pumps. The examples can also include metering pumps, such as plunger metering or diaphragm metering, centrifugal pumps, or magnetic pumps.

While descriptions and examples herein focus on an example of an axial flux motor integrated within the pump housing, the example are not limiting. The integration of an axial flux motor in accordance with the descriptions herein can include the motor within the pump case with little to no modification of the pump housing. In one example, the motor integrated into the pump is a radial flux motor. The integration of a radial flux motor would extend the shape of the integrated pump in the direction of the backplate. Namely, instead of the flat backplate securing the internal assembly within the pump housing, the pump housing can be extended or integrated with motor housing to house a radial flux motor. Such an integrated radial flux motor can include sealed stator and rotor components, similar to what is described with respect to the axial flux motor designs.

In one example, the radial flux motor includes a rotor coupled to or integrated with a shaft that is connected to or integrated with the impeller. In one example, the impeller includes an extended base or cylindrical section extending out from the impeller from a surface opposite the blades. The cylindrical portion can include magnets mounted to the surface of the cylinder to fit within an opening in a stator that has a cylindrical shape surrounding the extended base and magnets of the impeller. Thus, the same or similar principles of integrating a rotor to an impeller can be implemented in a radial flux motor design.

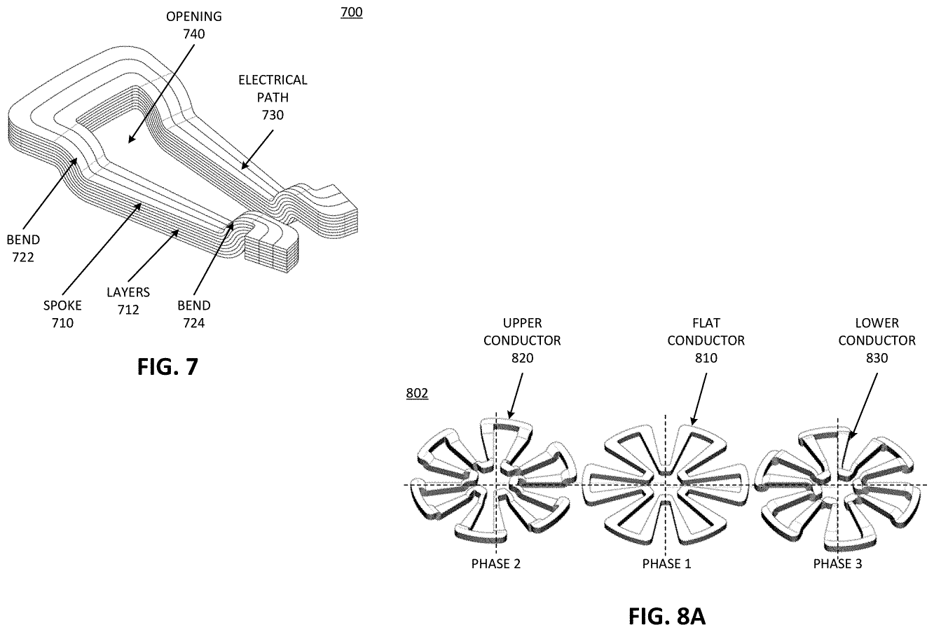

FIG. 7 is a diagram of an example of a conductor path with folding and bending for a stator with layers of coated conductor. Assembly 700 provides an example of a segment of stacked coated conductors. The segment illustrated in assembly 700 includes spoke 710. Spoke 710 represents a stack of spokes of different layers 712 of conductors. Each spoke 710 provides an electrical path 730 for current. With coated layers 712, the various electrical paths 730 can be separate for each layer. The layers can be connected variously in parallel or series or a combination to provide different combinations of current capacity or different voltages.

Opening 740 represents a space between two spokes 710. In one example, assembly 700 includes opening 740, which can provide space to nest with one or more other layers of conductors. In one example, assembly 700 includes bend 722 and bend 724 to enable the nesting of multiple stacks of layers of conductors. In one example, assembly 700 is nested with at least one stack of conductor layers that has no bends. In one example, assembly 700 is nested with at least one stack of conductor layers that also has bends. In one example, where stacks of layers are nested, the bending changes the electrical path length of one stack as compared to another. Electronics of a controller can control the duty cycle of driving the different paths to account for the variations in electrical path length for different stacks.

In one example, assembly 700 is created with folding of electrical path 730 to provide the radial current path that provides field to drive the electromagnet motive force, and then the return path. The folding refers to the serpentine shape that results from various elements in accordance with assembly 700 coupled together to form a complete radial path (e.g., 360 degrees of folded path). The shape provided by the folding reduces the total path length verses two coils with a complete circular path.

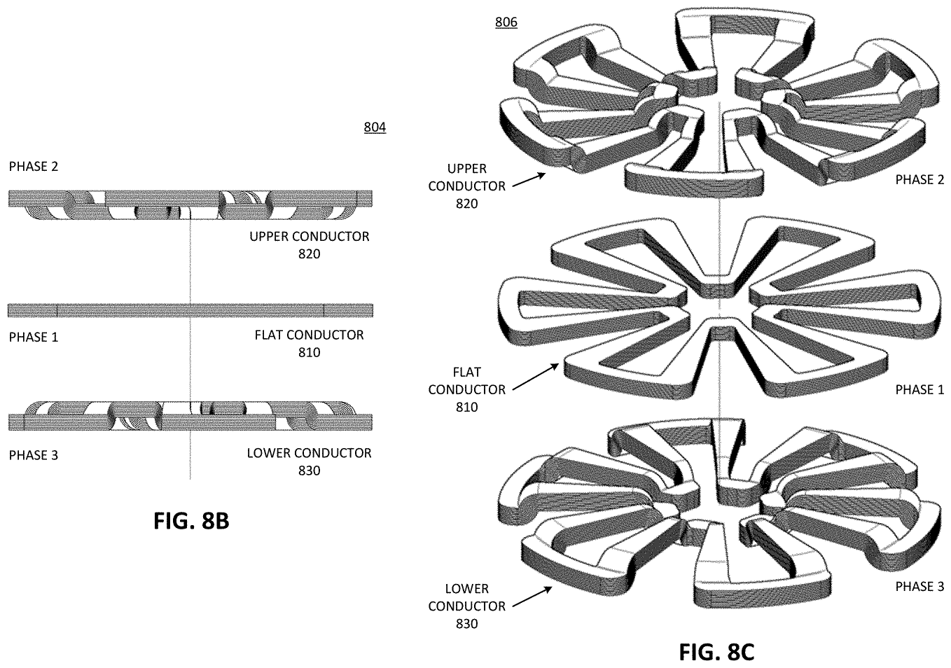

FIG. 8A is a diagram of an example of a coated conductor sheets with three phases. Diagram 802 illustrates three phases designed to be physically interwoven to produce low voltage and high eddy current. In one example, flat conductor 810, which can also be referred to as a flat coil, is designated as Phase 1. The phase designation is arbitrary, and the system can be designed with different phases for different nested coils.

Diagram 802 illustrates upper conductor 820 or an upper coil, which is designated as Phase 2. Diagram 802 illustrates lower conductor 830 or a lower coil, which is designated as Phase 3. Again, the labels of the phases is arbitrary, and is shown for purposes of illustration only. Additionally, designation of conductor 820 as an “upper” coil and conductor 830 as a “lower” coil is an arbitrary designation based on the specific orientation of diagram 802. In one example, a motor with a three phase stator in accordance with diagram 802 can be mounted and used with the plane of conductors 810, 820, and 830 parallel with the ground, or perpendicular to the ground, or at any arbitrary angle with respect to the ground.

Diagram 802 includes crosshairs over each of conductors 810, 820, and 830, which demonstrates relative positions to each other for nesting. For example, taking flat conductor 810 as a “middle” conductor, the crosshairs align over the center point of the conductor. For upper conductor 820, the conductor is shown slightly offset above the center point of the crosshairs, and for lower conductor 830, the conductor is shown slightly offset below the center point of the crosshairs. It will be observed relative to the crosshairs how the crosshairs align on one edge of a spoke on upper conductor 820, which aligns with a complementary edge of a spoke of lower conductor 830, while the crosshair splits the middle between two spokes of flat conductor 810. It will be understood how the conductors can nest together, and with the bends in the upper and lower conductors, there will be a relatively flat stator core surface made up of alternating spokes of the three different phase stacks.

An implementation of a flat stator core can be made up of roughly coplanar stacks interleaved with each other to position spokes of different stacks adjacent to each other. It will be understood that the path length of flat conductor 810 is actually shorter than the two bent or contoured coils of conductors 820 and 830. Traditionally, such uneven path lengths would produce uneven force. In one example, a solid state controller (e.g., digital microcontroller or microprocessor) drives the stator assembly of diagram 802 to compensate digitally for the uneven path lengths. The digital compensation enables lower cost mechanical systems in exchange for more complex control software.

Thus, as illustrated, in one example a stator assembly includes a multiple stacks of multiple layers each. Each stack includes multiple layers of coated conductor coils, which can be electrically connected in accordance with any example described herein. In one example, some or all layers of a single conductor stack are connected in parallel to lower a required voltage to drive the EMF (electromagnetic frequency). In one example, some or all layers of a single conductor stack are coupled in series to increase the required voltage. In one example, the stacks include two or more coils in a serpentine shape where the coils fold over each other, to form a structure for the stator. It will be understood that the nesting of layers inside each other can increase the total amount of conductor per volume. Nesting the layers can additionally minimize the wearing and potential shorting of adjacent layers.

FIG. 8B is a diagram of an example of a cross section view of the stacking of the three phases of conductors into a stator assembly. Diagram 804 illustrates a cross section of the stator assembly of diagram 802 of FIG. 8A, with the different stacks of conductors aligned with respect to their center points.

The perspective of diagram 804 more clearly indicates the curvature of upper conductor 820 and lower conductor 830, while the stack of conductor 810 is flat. Interleaving such stacks of layers of conductor can almost completely fill the gaps in the stator core, which provides a maximum amount of conductor in a given volume to place adjacent a magnet array. Interleaving the stacks results in a stator core with first, second, and third stacks of conductor that have the main conductive portion in a common plane or substantially coplanar. Increasing the amount of conductor in the given volume can reduce the resistive losses. In one example, each phase includes a stack of layers of thin sheets of aluminum or other conductor material which lowers the eddy current losses by the square of the thickness of the plate verses a solid coil of the same shape. The thin sheet can decrease eddy current losses while increasing the voltage required to drive the current.

FIG. 8C is a diagram of an example of a perspective view of the stacking of the three phases of conductors into a stator assembly. Diagram 806 illustrates another perspective of interleaving stacks of conductor. While illustrated as Phase 1, Phase 2, and Phase 3, in one example, the stacked assembly can include a single phase, two phases, or three phases, depending on how the conductors are connected. Because there are multiple layers of conductor in each stack, in one example, the stator assembly of diagram 806 can accommodate more than three phases. Increasing the number of phases decreases the angular rotation between maximum torque, and reduces the current carrying capabilities by requiring narrower conductors.

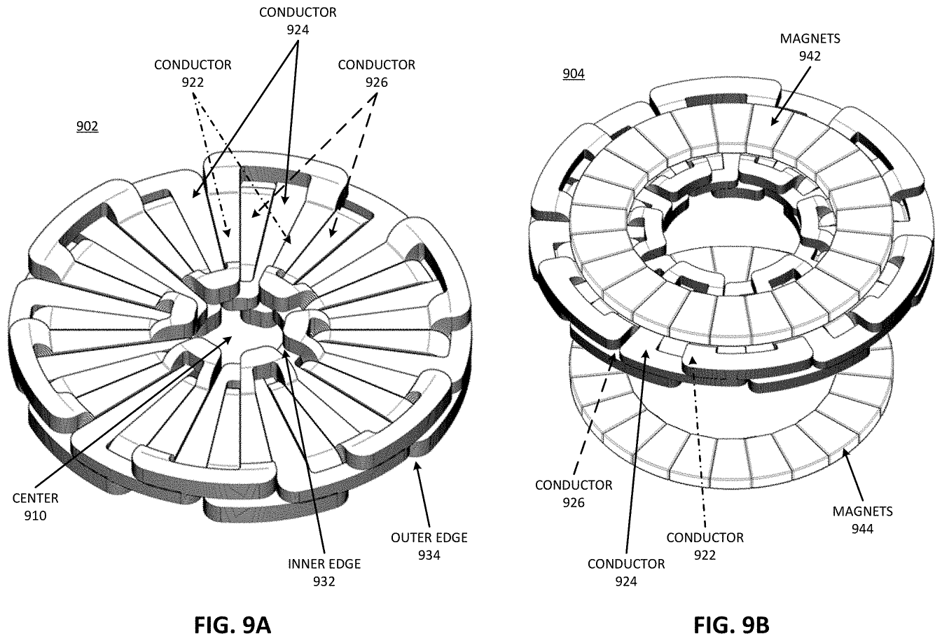

FIG. 9A is a diagram of an example of an assembly of a three phase stator core. Assembly 902 provides one example of a stator assembly in accordance with diagrams 802, 804, and 806. Assembly 902 can provide one example of a 3-phase system. Assembly 902 includes nested conductors 922, 924, and 926. Each reference number in the drawing includes arrows pointing to closest spokes of the same conductor coil, which are separated by spokes of interleaved conductor coils. Thus, for example, assembly 902 includes, moving from left to right, a spoke of conductor 924, adjacent a spoke of conductor 922, adjacent a spoke of conductor 926, adjacent a spoke of conductor 924, and repeating the pattern.

Assembly 902 includes radial current paths provided by conductors 922, 924, and 926. The radial current paths allow current to flow radially with respect to center 910, which provides an interface with an axle. Inner edge 932 is proximate center 910, and outer edge 934 is at a point of the conductors farthest from center 910. Center 910 represents a stator center or a center of the stator core formed by the stacked conductors. It will be observed that each spoke varies in cross sectional area going from inner edge 932 to outer edge 934, which increases the amount of conductor material that can be included in the stator.

In one example, assembly 902 includes a flat radial section to allow a small gap between an axial flux magnetic array. The flat radial section includes the surface of the spoke of coated conductors between inner edge 932 and outer edge 934. Inner edge 932 provides an inner connection between adjacent spokes of the conductor. Outer edge 934 provides an outer connection between adjacent spokes of the conductor. The flat radial section can provide a relatively large surface area for cooling. The design of assembly 902 also reduces the amount of material outside the magnetic field while still maintaining a path for the current.

In one example, assembly 902 can be applied as a stator core for a stator in accordance with an example of system 104. Certain descriptions of the stator represent a stator with a solid core and slots on the core, assembly 902 illustrates an alternative stator core that could be applied to an in-pump motor assembly. Assembly 902 can be modified in length of the spoke of the conductors to fit over the magnets of a hybrid rotor and impeller component, while leaving a gap in a middle for a bearing. In one example, assembly 902 could be attached to a back plate that would provide the back plate for the stator as well as for the internal assembly of the pump.

FIG. 9B is a diagram of an example of an assembly of a three phase stacked stator core with two magnet arrays. Assembly 904 provides one example of a stator assembly in accordance with assembly 902. In one example, assembly 904 is a 3-phase system. Assembly 904 includes nested conductors 922, 924, and 926. Each reference number in the drawing includes arrows pointing to closest spokes of the same conductor coil, which are separated by spokes of interleaved conductor coils.

Assembly 904 illustrates magnets 942 on one side of the stator conductors and magnets 944 on the opposite side of the stator conductors. It can be observed that with the curved structures at the outer edge and the inner edge of the conductor stack, magnets 942 and magnets 944 can fit approximately in the depression of the conductor stack or coil stack. The magnets can be secured to other components, not shown, to provide a rotor component to spin in response to charging of the stator conductor stack.

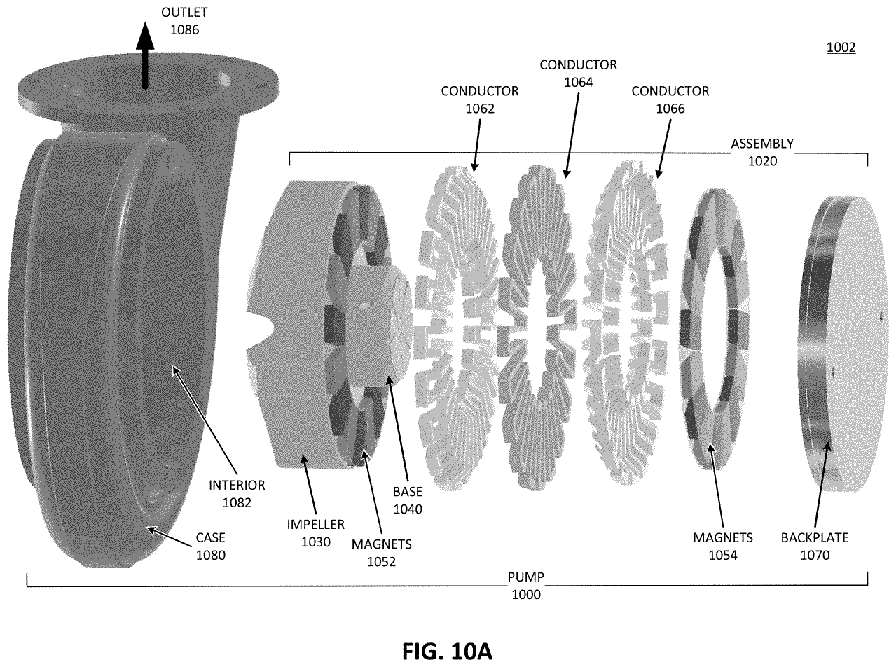

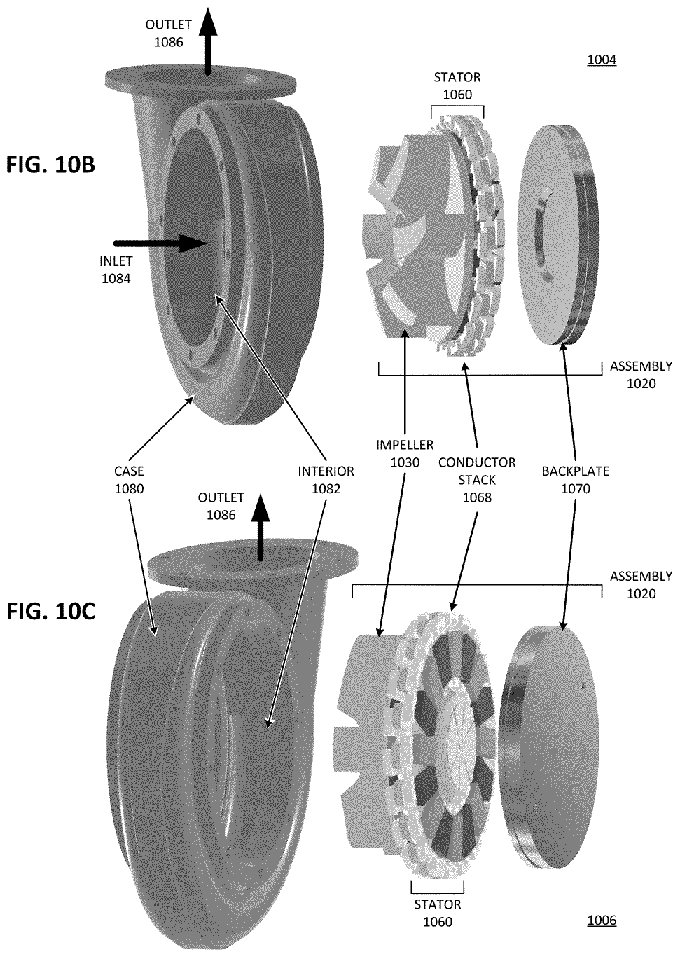

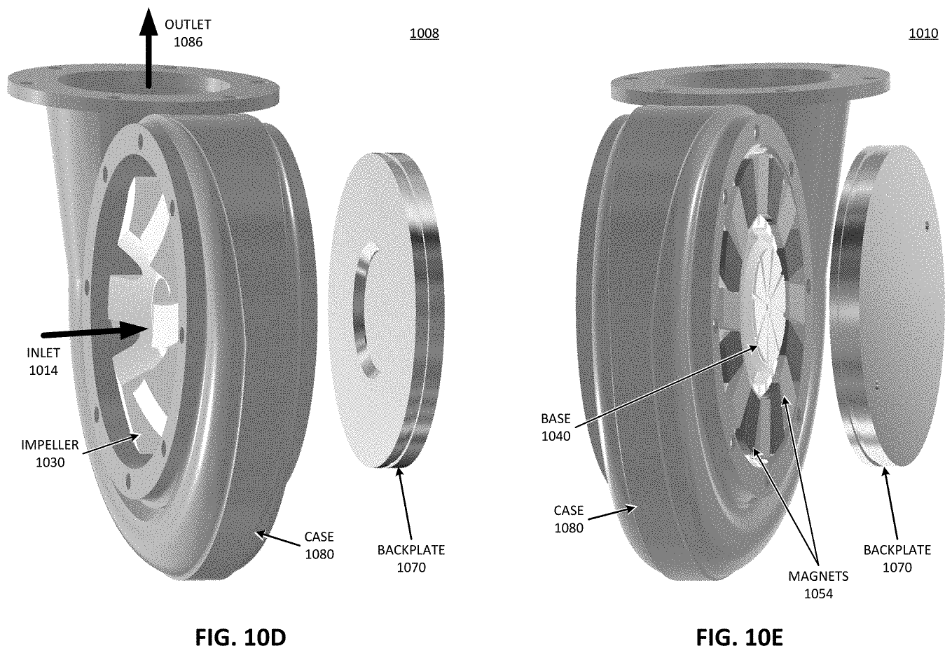

FIG. 10A is an example of a pump casing and pump core with a stacked stator core to be integrated together. View 1002 provides an example of pump 1000 having an internal assembly in accordance with an example of assembly 904, which can be a pump in accordance with an example of system 104. Pump 1000 can be an example of a pump in accordance with pump 600, with a different stator and rotor architecture.

Pump 1000 includes outlet 1086 to expel liquid. Pump 1000 includes assembly 1020, which represents an internal motor assembly with an integrated impeller and rotor to result in a pump with a single moving part. Assembly 1020 includes a stator made up of layers of stacked conductors, which interleave with each other. The stator conductor includes conductor 1062, conductor 1064, and conductor 1066.

Pump 1000 includes backplate 1070, which is a plate or structural component that covers the side of the pump opposite the one that interfaces with the fluid intake. Assembly 1020 includes impeller 1030 to convert velocity into pressure to pump the liquid from the inlet to outlet 1086. In one example, impeller 1030 includes magnets 1052 and base 1040. Base 1040 represents an extended base that can include a bearing in accordance with any example described. With magnets 1052 integrated on impeller 1030, the impeller can also function as the stator, and could be labeled as the stator. With pump 1000, in one example, assembly 1020 also includes magnets 1054 to be mounted on backplate 1070. In one example, assembly 1020 includes only magnets 1052. In an implementation with magnets 1054 mounted on backplate 1070, the magnetic flux balances on either side of the stator, reducing certain thrust forces within the motor. Conductor 1062, conductor 1064, and conductor 1066 can be selectively driven by a controller to cause the operation of the motor, which will then also cause the operation of the pump.

In one example, pump 1000 includes a volute housing or volute case, illustrated by case 1080. Pump 1000 illustrates the inside of the volute housing or casing inside, represented as interior 1082. Assembly 1020 will be combined and secured within interior 1082. Integrating assembly 1020 into case 1080 provides a simple system with a single moving part.

FIGS. 10B-10C are examples of the pump of FIG. 10A with the pump core assembled, as seen from two different perspectives. FIG. 10B illustrates view 1004 of pump 1000, with the various conductor stacks stacked together into stator 1060, and shows inlet 1084 into case 1080 to be driven out outlet 1086. FIG. 10C illustrates view 1006 of pump 1000, with the various conductor stacks stacked together into stator 1060, and shows the magnets on the back side of the stator.

View 1004 illustrates interior 1082 is seen from the perspective of the inlet, and shows the front of impeller 1030 and the interior portion of backplate 1070. View 1004 illustrates stator 1060 assembled next to the magnets on impeller 1030. Stator 1060 is made up of conductor stacks 1068. View 1006 illustrates interior 1082 from the perspective of the backplate, and shows the back or exterior surface of backplate 1070 as well as the magnets against stator 1060, which is against impeller 1030.

FIGS. 10D-10E are examples of the pump casing and pump core of FIG. 10A nested together, as seen from two different perspectives. FIG. 10D illustrates view 1008 with assembly 1020 enclosed within interior 1082 of case 1080. View 1008 illustrates inlet 1014 where fluid will enter the pump to be pumped out outlet 1086 by impeller 1030. The front plate of pump 1000 is not illustrated, but the final assembly would appear essentially identical to view 608 of FIG. 6D.

FIG. 10E illustrates view 1010 with assembly 1020 enclosed within interior 1082 of case 1080. View 1010 illustrates the back of assembly 1020, with magnets 1054 and base 1040 visible within interior 1082 of case 1080. Backplate 1070 will be secured to case 1080 and secure the motor assembly inside. The final assembly with backplate 1070 secured on would appear essentially identical to view 610 of FIG. 6E.

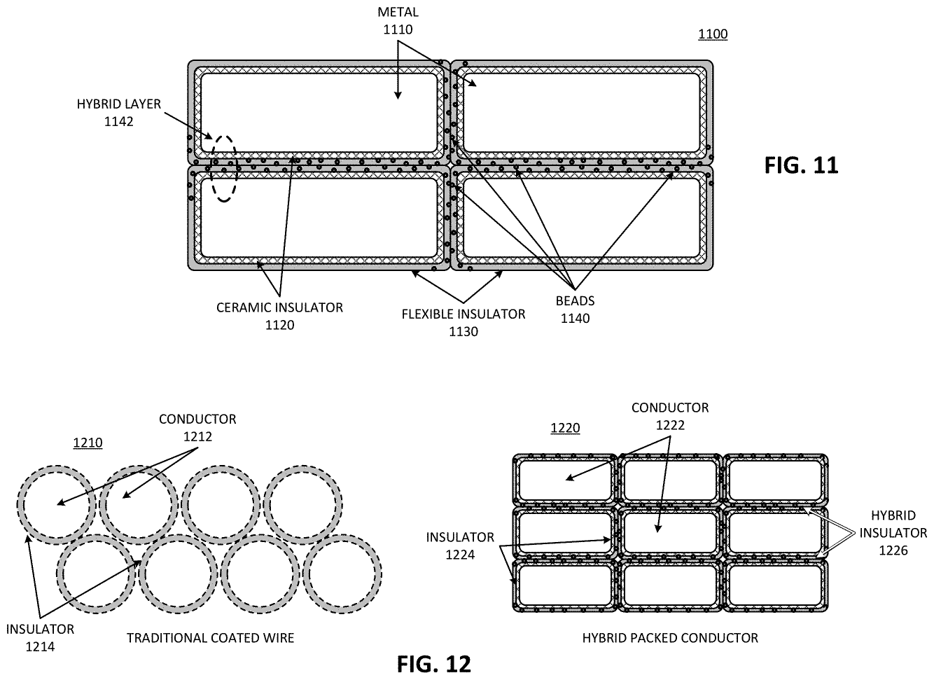

FIG. 11 is a diagram of an example of a hybrid conductor. Conductor 1100 represents a hybrid conductor for applications where wire will be stacked or wrapped on itself and under stress. For example, conductor 1100 can be a hybrid conductor for a motor. In one example, conductor 1100 is a conductor for wiring applications for transformers, motors, solenoids, electromagnets, laminations, or other electromechanical applications. Conductor 1100 can be applied as conductor for a stator assembly of a motor assembly to be integrated into a pump, in accordance with an example of stator 404 and stator 406.

Metal 1110 provides electrical conduction for conductor 1100. In one example, metal 1110 represents copper wire. In one example, metal 1110 represents an aluminum wire. Metal 1110 can be another metal to provide conduction. Metal 1110 is illustrated as having a rectangular cross-section. In one example, the rectangular cross-section is square. Metal 1110 can be referred to as a flat or ribbon type of wire. Metal 1110 can provide an example of a flat conductor or flat wire with a generally rectangular cross section.

Conductor 1100 can be referred to as a hybrid conductor, because metal 1110 is coated in two different types of insulator: a hard insulator and a soft or flexible insulator. Conductor 1100 includes ceramic insulator 1120, which directly contacts metal 1110 and adheres to the metal. Adhering refers to the mechanical connection of ceramic insulator 1120 to the metal. In one example, ceramic insulator 1120 is also chemically bonded to metal 1110. With a chemical bonding, ceramic insulator 1120 adheres directly to the surface of metal 1110, where at least a thin layer of the metal and ceramic interact chemically.

Ceramic insulator 1120 can be in a hard insulator such as a glass compound or a ceramic compound. Ceramic refers to a non-conductive material, such as a crystalline oxide (for example, a metal-oxide), a crystalline nitride (for example, a metal nitride), or a crystalline carbide. In one example, ceramic insulator 1120 is a glass compound, which refers to a crystalline structure that is translucent or transparent. As a crystalline structure, a glass compound can be considered a specific type of ceramic compound. Ceramic insulator 1120 provides electrical isolation between layers of metal 1110 even in high voltage applications. Ceramic insulator 1120 has good electrical isolation but is not flexible. Certain ceramics may not chemically adhere to metal or may not even mechanically adhere well to metals.

Flexible insulator 1130 represents a soft or flexible insulator that is directly in contact with ceramic insulator 1120. Flexible insulator 1130 can be like traditional insulation such as plastic, enamel, epoxy, polyimide film, or other relatively soft material that adheres to ceramic insulator 1120. Flexible insulator 1130 is a non-ceramic insulator or non-ceramic insulative coating. In one example, flexible insulator 1130 mechanically adheres to ceramic insulator 1120. In one example, flexible insulator 1130 mechanically and chemically adheres to ceramic insulator 1120.

Ceramic insulator 1120 and flexible insulator 1130 can be relatively thin layers of material. A single layer of insulation a micron thick on a 1 mm (millimeter) by 1 mm outer dimension square wire would have a cross section of 0.4 percent of the conductor volume. Nine wires with ⅓ mm×⅓ mm cross section would have 9 times the relative cross section of insulation or 3.6 percent, reducing the overall current carrying capability, which in turn would increase the resistance and lower the efficiency of a motor made with conductor 1100. Thus, the wires represented by metal 1110 can be coated by thin layers for ceramic insulator 1120 and flexible insulator, making the conductor what is termed magnet wire, where the insulation is as thin as practical for the power, current, voltage, and thermal requirements of the device.

While traditional insulator coatings can provide mechanical, electrical, and chemical insulation, they may still be susceptible to the vibrations and thermal cycling common in motor use, especially in higher power devices with constant use. The vibrations cause rubbing between the wires as they exert equal and opposite forces between the rotor and stator, which compresses traditional insulators and eventually leads to wear because of the creep of the insulation under heat and pressure, or other failure mechanisms.

In addition to ceramic insulator 1120 and flexible insulator 1130, conductor 1100 includes beads 1140, which turn flexible insulator 1130 into hybrid layer 1142. It will be observed that the circles or dots representing beads 1140 in conductor 1100 are only shown between layers of metal 1110. In one example, a practical application of conductor 1100 will include beads 1140 combined with the material for flexible insulator 1130 to surround all of metal 1110.

In one example, beads 1140 represent individual elements of a glass, ceramic, or metal oxide. In one example, beads 1140 represent individual balls of material. The balls can be spherical or some other rounded shape. In one example, beads 1140 represent individual elements of a powder, which refers to a material that may not have uniform shape or size, such as a powder of sapphire, a glass powder, or ceramic powder. In one example, the balls have relatively uniform shape and size. In one example, beads 1140 can be embedded into a non-ceramic insulative coating.

Conductor 1100 with hybrid layer 1142 provides a compound solution to provide magnet wire with a hard insulator, ceramic insulator 1120, to provide a hard coating that has good thermal transport properties. Ceramic insulator 1120 provides an insulator that does not fail under thermal expansion, vibration, or stress conditions, even if an arc passes through it. The combination of ceramic insulator 1120 and beads 1140 provides a hard and sturdy mechanical separation, which prevents both physical contact of the conductors, as well as maintaining spacing between them to prevent arcs and shorts. Ceramic insulator 1120 allows for a thin layer of conductor, which improves the cooling attributes of a motor or device using conductor 1100, because it has a high thermal conductivity. Thermal insulation will reduce cooling, which during high current operation will cause significant heating of the coils. Heating the coils can cause thermal expansion, cracking, and eventual failure. There is a large benefit to allowing thinner insulation that promotes distribution and cooling especially as the motion of the fluid with respect to the surfaces provides an almost ideal exchange of heat produced in the activity of creating electromechanical motion from electrical power.

With beads 1140, flexible insulator 1130 can be thinner as compared to traditional wiring, which means the flexible or organic coating will cause significant heating of the wire. Even when the wire heats up and flexible insulator 1130 softens, beads 1140 provide a layer to prevent shorting of the wire. Ceramic insulator 1120 should provide electrical isolation of the wires, but the reality is that if conductor 1100 is wrapped, ceramic insulator 1120 is subject to cracking, which could cause areas of potential vulnerability in the electrical isolation. Whereas flexible insulator 1130 could normally protect such areas, if flexible insulator 1130 softens under the pressure of use, such vulnerable areas could still be exposed, resulting in a short. With beads 1140, even if there are cracks or imperfections in ceramic insulator 1120 at the same time that flexible insulator 1130 is displaced, the beads can maintain sufficient distance between layers to prevent a short.

In one example, the rectangular shape of metal 1110 provides a geometric advantage relative to the use of beads 1140. With the use of a rectangular metal 1110, beads 1140 can distribute the load on the metal due to the stresses of use of a motor or other device. In addition to spreading the load, the rectangular shape increases the packing density, given that rectangles pack denser than circles. In one example, the size of beads 1140 is designed to maintain a minimal gap between layers of metal 1110. In one example, conductor 1100 includes thousands of beads between each portion of metal 1110.

In one example, conductor 1100 includes aluminum wire as metal 1110, which can be anodized with a thin layer of oxide to provide ceramic insulator 1120. The aluminum oxide can provide insulation as well as an oxide surface to improve the adhesion of flexible insulator 1130. In one example, hybrid layer 1142 includes flexible insulator 1130 as a plastic, epoxy, or other matrix material mixed with a powder or beads of glass, aluminum oxide, or other suitable material, binding them to the surface of metal 1110, or more specifically, the surface of ceramic insulator 1120 on metal 1110.

Under the above example, the combination of materials of conductor 1100 allows flexing, with the aluminum oxide layer and glass beads providing enhanced insulation, and the spacing material of the aluminum oxide and glass beads preventing mechanical movement that would reduce the thickness of the binding material as it softens. The combination thus prevents the shorting typically encountered with wires that would use only one type of insulator, without the risk of defects in either layer of insulator. Such a combination can also allow an affordable composite solution when the ceramic is a simple anodized aluminum process, coupled with a simple enamel dip, combined with microbeads of glass, ceramic, or other high dielectric hard materials that have suitable spacing. The suitable spacing refers to a size that will maintain the spacing between layers of metal 1110 that would be required to prevent shorting even when conducting voltages expected for a given application.

It will be understood that conductor 1100 can have many variables, depending on the intended application. For example, ceramic insulator 1120 can have variations in relative thickness based on the voltages of the application. Additionally, or alternatively, the ratio of beads 1140 (or a hard powder) to binder material for hybrid layer 1142 can be tailored to the desired application, with thicker insulation for higher voltages.

In one example, conductor 1100 uses flat copper wire coated with a hybrid of inert non-conductive filler or spacer material such as glass beads or aluminum oxide powder. In one such example, conductor 1100 includes metal 1110 and no separate ceramic insulator 1120. Rather, the ceramic can be entirely applied in the form of beads 1140 within flexible insulator 1130. Such an application would provide wire that performs equivalently to traditional magnet wire, which is hardier and less prone to shorting, arcing, or burning out. In one example, metal 1110 can be aluminum, with ceramic insulator 1120. Alternatively, a ceramic coating can be applied to copper wire.

FIG. 12 is a diagram of an example of a hybrid conductor winding with spacer separation. Diagram 1210 represents a cross-section of a coil wrapping of a traditional coated wire. Diagram 1220 represents a cross-section of a coil wrapping of a hybrid packed conductor in accordance with an example of conductor 1100.

In accordance with diagram 1210, the traditional wire has conductor 1212 with insulator 1214. Insulator 1214 can be thin to make the traditional wire a magnet wire winding. Traditionally, the winding of diagram 1210 may include binding materials between the individual wires, which is not explicitly shown, but which would occupy some or all of the empty space between the wires. Thus, a bundle of traditional magnet wire can be fused into a single mechanical mass by heating or baking the assembly once it is wound or formed.

Despite the use of bindings to create a solid mass of a winding assembly, such devices are subject to burnout for the same reasons identified above with respect to traditional wire assemblies. Namely, the use of the binding tends to trap heat in the wiring as the device is cycled over and over, increasing the temperature. For binding materials that are soft enough to penetrate to most space between the wires, the binding material tends to soften at high temperatures, resulting in vibration pressure against the wires, which can cause electrical shorting. Binding material that can withstand higher temperatures may not provide as much gap coverage, and may still allow enough vibration pressure to allow failures. Regardless, if the binding material is not able to entirely fill the gaps in the wiring, there is more likelihood that adjacent wires can vibrate against each other, resulting in the failures mentioned previously.

It will be understood that even the application of beads in a composite coating of hard coating and flexible coating as mentioned above for conductor 1100, with round wires the beads would tend to be displaced. An electrical short with the round wires only requires a point on the circumference of one wire to be electrically close enough to a point on the circumference of another wire. The use of beads may make such an occurrence less likely. Thus, the use of a hard insulator and a soft insulator with beads could be applied to round wire such as that of diagram 1210. However, it is expected that the failure rate of such an application would still be significantly higher than that of a rectangular conductor.

In accordance with diagram 1220, the hybrid packed conductor has a type of wire that is square, rectangular, ribbon, or flat with a hard insulator coating directly in contact with the metal and a flexible insulator coating surrounding the hard insulator coating. Thus, conductor 1222 represents a metal wire or other conductor wire having an increased exposed surface area relative to conductor 1212 of diagram 1210. Increasing the exposed surface area means that conductors 1222 mechanically have lower contact pressure relative to conductor 1212, because the same forces are spread over a much greater area as compare to two round wires. Additionally, relative to diagram 1210, diagram 1220 has more conductor in the same area, which provides denser packing to allow more current flow, which will increase the magnetic flux of the stator. The increase in conductor and improved resistance to burnout provide better performance of the wrappings, even if the wire assembly is made without packing material as previously done.

Thus, diagram 1220 provides a wrapping with a hybrid insulation layer on the conductors that provides higher temperature, stronger and more durable insulation for electrical wiring for motors and other electromagnetic applications. Hybrid insulator 1226 represents the hybrid insulation layer, which can be in contact with hard insulator 1224. The conductor bundle of diagram 1220 has almost ideal packing density, very high thermal transport characteristics, and good electrical insulation characteristics. For applications where abrasion, force, temperature, and environmental factors can cause wiring to fail, the wrapping of diagram 1220 has many advantages over the traditional coated wire wrapping of diagram 1210. The hybrid insulation is minimal compared to bulky and expensive solutions, and is relatively inexpensive to apply.

Hard insulator 1224 may still be susceptible to minor cracking due to bending, stress, and thermal expansion. Traditional soft insulator could still expose such defects for the same reasons that the bending, stress, and thermal expansion will introduce stress that can compress and displace the soft insulator material. However, hybrid insulator 1226 with beads, which may include a powder, such minor cracking does not produce a failure mechanism. The beads will maintain sufficient electrical distance between layers. The nature of the beads may even cause them to collect in areas of cracking, due to the disruption or imperfection in the crystalline surface structure. Collection of beads in cracks would ensure that cracks are not expose to cracks in adjacent layers, because the beads will maintain the electrical distance between the layers, preventing shorting.

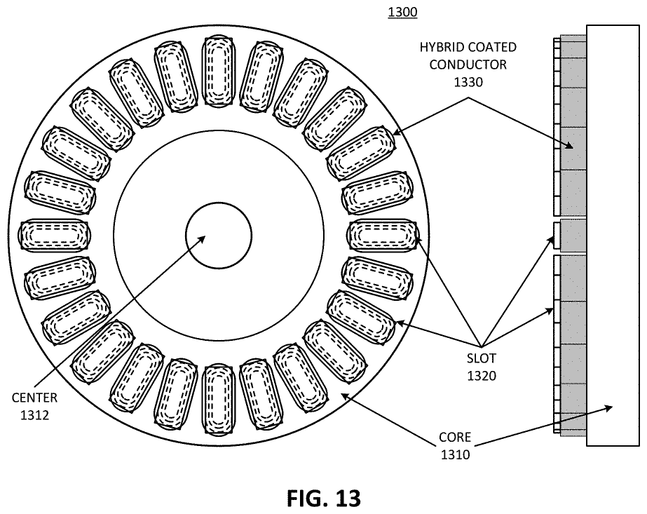

FIG. 13 is a diagram of an example of a motor assembly with coils of hybrid conductor around wrapping slots. Stator 1300 represents a stator assembly for a motor. Stator 1300 includes hybrid insulated conductor in accordance with any example herein.

Stator 1300 includes core 1310, which can be a solid metal core, such as an iron core or a steel core. The diagram includes a top view of stator 1300 on the left and a side view of the stator on the right. Core 1310 includes center 1312. In one example, core 1310 is a disk of magnetic metal. In one example, core 1310 is an iron disk. Core 1310 includes multiple slots or posts that radially surround center 1312. More specifically, considering the top view of stator 1300 as a circle with the center at center 1312, slots 1320 are centered on radius lines of the circle, with one end of the slot toward center 1312, and the other end toward an outer edge of stator 1300.

Slots 1320 act as posts around which conductor can be wrapped. In one example, slots 1320 are wrapped with hybrid coated conductor 1330 in accordance with any hybrid conductor described. More specifically, hybrid coated conductor 1330 includes a conductive core such as metal, a hard insulator coating on the conductive core, and a soft insulator coating on the hard insulator coating. In one example, the soft insulator coating includes beads, as ceramic or glass balls or spheres, or powder. In one example, the beads are part of the material used to make the soft insulator coating. In one example, the soft insulator coating is created, and then beads are applied to the coating. In one example, the soft insulator coating includes multiple soft layers, which could be multiple layers of the same material, or layers of different material.

A motor that applies stator 1300 can run hotter without failing. Stator 1300 can allow a motor to be driven harder with more current, providing greater torque in a smaller package. Motors are typically sized for the peak power requirements, even if the peak only lasts a few seconds. With the ability to overdrive the motor based on the use of stator 1300, the motor can be designed to nominal power requirements, allowing the peak power to be obtained with momentary surges in power. The momentary surges would not risk failure because of the thermal performance and the electrical separation of hybrid coated conductors 1330. Motors that can run at higher temperature can have greater power densities, lower weight, lower cost, and greater performance. In some applications, a motor in accordance with stator 1300 can reduce cooling systems that would otherwise add weight, cost, and complexity to the total system. Stator 1300 can be applied in radial motor applications, such as in an internal assembly for a pump in accordance with an example of system 104. Stator 1300 represents a stator in accordance with an example of stator 406.

In general with respect to the descriptions herein, in one aspect a pump includes: a casing having an inlet to receive fluid and an outlet to expel fluid; an impeller to rotate inside the casing to create low pressure at the inlet and increase pressure to expel the fluid from the outlet; a rotor physically connected to the impeller, the rotor including permanent magnets arranged radially around a surface of the rotor opposite a connection to the impeller; and a stator assembly within the casing, adjacent the rotor, the stator assembly having a stator core with coils wrapped around the core, the coils including electrically controllable conductors to selectively, magnetically couple to the permanent magnets, to drive the rotor with axial flux.

In one example, the fluid comprises a gas or a liquid. In one example, the casing comprises a volute casing. In one example, the casing comprises a diffuser casing. In one example, the inlet comprises an inlet to a center of the impeller. In one example, the rotor comprises permanent magnets within a protective coating. In one example, adjacent permanent magnets of the rotor having opposite magnetic poles. In one example, the rotor further comprises a bearing plate extending within a center of the permanent magnets at a center of the surface of the rotor opposite the connection to the impeller. In one example, the bearing plate comprises fluid channels extending from a center of the bearing plate radially out toward the permanent magnets. In one example, the bearing plate comprises wedge shapes that are thinner in a center of the bearing plate relative to at an edge of the bearing plate, to create higher pressure at the edge of the bearing plate. In one example, the stator core comprises a steel plate with slots for the coils, and wherein the coils comprise flat conductors wrapped around the slots. In one example, the flat conductors comprise coated conductor including: a metal having a generally rectangular cross-section; a ceramic coating bonded to the metal; and a non-ceramic insulative coating over the ceramic coating, including non-conductive beads embedded in the non-ceramic insulative coating. In one example, the conductors comprise conductors within a protective coating. In one example, the stator assembly includes electrically controllable conductors to be driven in multiple phases. In one example, the pump includes: a thrust bearing.

In general with respect to the descriptions herein, in one aspect a pump includes: a casing having an inlet to receive fluid and an outlet to expel fluid; an impeller to rotate inside the casing to create low pressure at the inlet and increase pressure to expel the fluid from the outlet; a rotor physically connected to the impeller, the rotor including blades to face the inlet, and including a cylindrical base extending away from a surface of the impeller opposite the blades, the surface of the cylindrical base having permanent magnets arranged radially around the base; and a stator assembly within the casing, surrounding the cylindrical base of the rotor, the stator assembly having a stator core with coils wrapped around the core, the coils facing the permanent magnets, the coils including electrically controllable conductors to selectively, magnetically couple to the permanent magnets, to drive the rotor with radial flux.

In one example, the fluid comprises a gas or a liquid. In one example, the inlet comprises an inlet to a center of the impeller. In one example, the rotor comprises permanent magnets within a protective coating. In one example, adjacent permanent magnets of the rotor having opposite magnetic poles. In one example, the rotor further comprises a bearing plate extending within a center of the permanent magnets at a center of the surface of the rotor opposite the connection to the impeller. In one example, the bearing plate comprises fluid channels extending from a center of the bearing plate radially out toward the permanent magnets. In one example, the bearing plate comprises wedge shapes that are thinner in a center of the bearing plate relative to at an edge of the bearing plate, to create higher pressure at the edge of the bearing plate. In one example, the stator core comprises a steel plate with slots for the coils, and wherein the coils comprise flat conductors wrapped around the slots. In one example, the flat conductors comprise coated conductor including: a metal having a generally rectangular cross-section; a ceramic coating bonded to the metal; and a non-ceramic insulative coating over the ceramic coating, including non-conductive beads embedded in the non-ceramic insulative coating. In one example, the conductors comprise conductors within a protective coating. In one example, the stator assembly includes electrically controllable conductors to be driven in multiple phases. In one example, the pump includes: a thrust bearing. In one example, the stator core comprises a steel plate with slots for the coils, and wherein the coils comprise flat conductors wrapped around the slots. In one example, the flat conductors comprise coated conductor including: a metal having a generally rectangular cross-section; a ceramic coating bonded to the metal; and a non-ceramic insulative coating over the ceramic coating, including non-conductive beads embedded in the non-ceramic insulative coating.

In general with respect to the descriptions herein, in one aspect a pump includes: a casing having an inlet to receive fluid and an outlet to expel fluid; an impeller to rotate inside the casing to create low pressure at the inlet and increase pressure to expel the fluid from the outlet; a rotor physically connected to the impeller, the rotor including permanent magnets arranged radially around a surface of the rotor opposite a connection to the impeller; and a stator assembly within the casing, adjacent the rotor, the stator assembly having a stack of multiple layers of coated conductor having multiple spokes, with a spoke electrically coupled with an inner connection proximate a stator center point to an adjacent spoke of the layer, and electrically coupled with an outer connection proximate a stator outer edge to a different adjacent spoke of the layer, wherein the conductor has a rectangular cross section wherein the spoke has a varying width narrower toward the inner connection and wider toward the outer connection, the coated conductor having an insulative coating chemically bonded to the conductor, the coated conductors electrically controllable to selectively, magnetically couple to the permanent magnets, to drive the rotor with axial flux.

In one example, the fluid comprises a gas. In one example, the fluid comprises a liquid. In one example, the casing comprises a volute casing. In one example, the casing comprises a diffuser casing. In one example, the inlet comprises an inlet to a center of the impeller. In one example, the rotor comprises permanent magnets within a protective coating. In one example, adjacent permanent magnets of the rotor having opposite magnetic poles. In one example, the permanent magnets comprise first permanent magnets, and further comprising: a backplate to secure the impeller, the rotor, and the stator assembly within the casing; and second permanent magnets arranged radially on an inner surface of the backplate to arrange the first permanent magnets to one side of the stator assembly and the second permanent magnets to an opposite side of the stator assembly. In one example, the rotor further comprises a bearing plate extending within a center of the permanent magnets at a center of the surface of the rotor opposite the connection to the impeller. In one example, the bearing plate comprises fluid channels extending from a center of the bearing plate radially out toward the permanent magnets. In one example, the bearing plate comprises wedge shapes that are thinner in a center of the bearing plate relative to at an edge of the bearing plate, to create higher pressure at the edge of the bearing plate. In one example, the stator assembly includes a plurality of stacks of multiple layers of coated conductor, wherein the stacks comprises a first stack to nest with a second stack, wherein spokes of the first stack interleave adjacent to and substantially coplanar with spokes of the second stack. In one example, the stacks includes a first stack, a second stack, and a third stack, the three stacks to nest with each other in a first plane, wherein between two spokes of the first stack, one spoke of the second stack and one spoke of the third stack interleave adjacent to each other with the two spokes of the first stack, the one of the second stack, and the one spoke of the third stack to be in a second plane parallel to the first plane, wherein the inner connection and outer connection of the first stack are coplanar with the first plane, wherein spokes of the second stack include a bend, with the inner connection of the second stack to rest on top of the inner connection of the first stack and the outer connection of the second stack to rest on top of the outer connection of the first stack, and wherein spokes of the third stack include a bend, with the inner connection of the first stack to rest on top of the inner connection of the third stack and the outer connection of the first stack to rest on top of the outer connection of the third stack. In one example, the spokes include multiple parallel current paths aligned orthogonal to motion of magnetic poles of the permanent magnets. In one example, the conductors comprise conductors within a protective coating. In one example, the stator assembly includes electrically controllable conductors to be driven in multiple phases. In one example, the pump includes: a thrust bearing.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A pump comprising:
a casing having an inlet to receive fluid and an outlet to expel fluid and an enclosed space to be filled with the liquid when the pump operates;
a rotor within the enclosed space to rotate inside the casing, the rotor including first permanent magnets on a first surface of the rotor, the first permanent magnets arranged radially around the first surface of the rotor opposite a second surface of the rotor, wherein the second surface of the rotor has impeller fins that extend away from the second surface, within the enclosed space, wherein when the rotor rotates, the impeller fins rotate to create low pressure at the inlet and increase pressure to expel the fluid from the outlet, the rotor including a bearing plate extending within a center of the first permanent magnets at a center of the surface of the rotor opposite the connection to the impeller; and
a stator assembly within the casing, within the enclosed space adjacent the rotor, the stator assembly having a stack of multiple layers of coated conductor having multiple spokes, with a spoke electrically coupled with an inner connection proximate a stator center point to an adjacent spoke of the layer, and electrically coupled with an outer connection proximate a stator outer edge to a different adjacent spoke of the layer, wherein the conductor has a rectangular cross section wherein the spoke has a varying width narrower toward the inner connection and wider toward the outer connection, the coated conductor having an insulative coating chemically bonded to the conductor, the coated conductors electrically controllable to selectively, magnetically couple to the permanent magnets, to drive the rotor with axial flux.

2. The pump of claim 1, wherein the fluid comprises a gas.

3. The pump of claim 1, wherein the fluid comprises a liquid.

4. The pump of claim 1, wherein the casing comprises a volute casing.

5. The pump of claim 1, wherein the casing comprises a diffuser casing.

6. The pump of claim 1, wherein the inlet comprises an inlet to a center of the impeller.

7. The pump of claim 1, wherein the rotor comprises permanent magnets within a protective coating.

8. The pump of claim 1, wherein adjacent permanent magnets of the rotor having opposite magnetic poles.

9. The pump of claim 1, wherein the permanent magnets comprise first permanent magnets, and further comprising:
a backplate to secure the impeller, the rotor, and the stator assembly within the casing; and
second permanent magnets arranged radially on an inner surface of the backplate to arrange the first permanent magnets to one side of the stator assembly and the second permanent magnets to an opposite side of the stator assembly.

10. The pump of claim 1, wherein the bearing plate comprises fluid channels extending from a center of the bearing plate radially out toward the permanent magnets.

11. The pump of claim 1, wherein the bearing plate comprises wedge shapes that are thinner in a center of the bearing plate relative to at an edge of the bearing plate, to create higher pressure at the edge of the bearing plate.

12. The pump of claim 1, wherein the stator assembly includes a plurality of stacks of multiple layers of coated conductor, wherein the stacks comprises a first stack to nest with a second stack, wherein spokes of the first stack interleave adjacent to and substantially coplanar with spokes of the second stack.

13. The pump of claim 12, wherein the stacks includes a first stack, a second stack, and a third stack, the three stacks to nest with each other in a first plane, wherein between two spokes of the first stack, one spoke of the second stack and one spoke of the third stack interleave adjacent to each other with the two spokes of the first stack, the one of the second stack, and the one spoke of the third stack to be in a second plane parallel to the first plane, wherein the inner connection and outer connection of the first stack are coplanar with the first plane, wherein spokes of the second stack include a bend, with the inner connection of the second stack to rest on top of the inner connection of the first stack and the outer connection of the second stack to rest on top of the outer connection of the first stack, and wherein spokes of the third stack include a bend, with the inner connection of the first stack to rest on top of the inner connection of the third stack and the outer connection of the first stack to rest on top of the outer connection of the third stack.

14. The pump of claim 12, wherein the spokes include multiple parallel current paths aligned orthogonal to motion of magnetic poles of the permanent magnets.

15. The pump of claim 1, wherein the conductors comprise conductors within a protective coating.

16. The pump of claim 1, wherein the stator assembly includes electrically controllable conductors to be driven in multiple phases.

17. The pump of claim 1, further comprising:
a thrust bearing.
